(19) United States
(12) Patent Application Publication
(10) Pub. No.: US 2014/0189742 A1
(43) Pub. Date: Jul. 3, 2014

(54) METHOD AND APPARATUS FOR PROVIDING BROADCAST SERVICE THROUGH HAND MOTION DETECTION

(71) Applicant: Alticast Corporation, Seoul (KR)

(72) Inventors: Da-Hye Hyoung, Gwangju (KR); Gang Min Lee, Seoul (KR)

(73) Assignee: Alticast Corporation

(21) Appl. No.: 13/926,586

(22) Filed: Jun. 25, 2013

(30) Foreign Application Priority Data
Dec. 28, 2012 (KR) 10-2012-0155824

(51) Int. Cl. H04N 21/422; H04N 21/482

(52) U.S. Cl. CPC H04N 21/42204; H04N 21/482
USPC 725/44

(57) ABSTRACT

A method for providing broadcast service includes: (a) receiving schedule information for a multiple number of broadcast programs from a headend; (b) outputting a program selected by a user as a full screen; and (c) outputting a program navigation page by using the schedule information of the multiple broadcast programs if a pre-designated hand motion is detected. The program navigation page includes one of a category list page and a program list page, the category list page containing categories grouped according to use time, and the program list page containing programs belonging to each category. Depths are assigned in the order of the category list page, the program list page, and the A/V page, from higher to lower depths. A movement from a higher to a lower depth and a movement from a lower to a higher depth are performed via hand motions having different directionalities.

### CROSS-REFERENCE TO RELATED APPLICATIONS

This application claims the benefit of Korean Patent Application No. 10-2012-0155824 filed on Dec. 28, 2012, the disclosure of which is incorporated herein by reference in its entirety.

### TECHNICAL FIELD

The present invention relates to a method and apparatus for providing broadcast service through hand motion detection, more particularly to a method and apparatus that allow the user to easily and intuitively navigate through the user's desired programs and access various services through hand motions.

### BACKGROUND ART

In the past, a TV set was for a unidirectional service, providing the user with a limited function such as watching live programs. As a result of active research on digital standards in recent times, broadcast signals including video, audio, and data can now be compressed into digital signals, thus allowing multiple channels, and network processing capacity has also increased, allowing bidirectional broadcast services.

Nowadays, broadcast services offer more than simple, live programs of a unidirectional nature, providing on-demand program services according to the user's request as well as viewing reservation services for booking live programs that are to be provided at a future time. Also, by monitoring the viewing behavior of each user, the viewership ratings of live programs and the popularity of on-demand programs can be computed in real time, enabling broadcasting businesses to provide a list of live programs having high viewership ratings or high popularity to the broadcast receiving side. Furthermore, current broadcasting businesses not only provide audio/video (A/V) signals for live or on-demand programs but also provide various information, such as the synopsis, the cast, etc., of the programs, as supplementary information. In spite of the broadcast services thus providing numerous types of programs and information in recent times, there is still the inconvenience of having to use a remote control with a limited keypad.

In order to increase the user's convenience in accessing services, a type of remote control has recently been developed which is equipped with various key buttons that allow direct access to certain desired services. Furthermore, some types of remote control may include a pointing function, such as that implemented by a touch screen or a mouse. However, even supposing that various key buttons, a touch keypad, and a pointing function are provided, TV services inherently involve navigating through several depths of a menu, and as such, still entail a source of inconvenience. That is, in the case of a TV service, even when a desired program has been selected, an existing type of remote control may not satisfy the user's need for easily browsing other programs or easily searching for program-related information.

### SUMMARY

To resolve the problems described above, an aspect of the invention proposes a method and apparatus for providing broadcast service through the detection of hand motions that enable the user to easily and intuitively navigate to a desired program and to quickly access various information related to a program.

To achieve the objective above, an embodiment of the invention provides a method for providing broadcast service at a broadcast receiving device through a detection of a user's hand motions, the method comprising: (a) receiving schedule information for a multiple number of broadcast programs from a headend; (b) outputting a program selected by a user as a full screen; and (c) outputting a program navigation page by using the schedule information of the multiple broadcast programs if a pre-designated hand motion is detected. Here, the program navigation page includes one of a category list page and a program list page, the category list page containing a multiple number of categories grouped according to use time, and the program list page containing programs belonging to each category. Defining the screen outputted in step (c) as an A/V page, depths are assigned in the order of the category list page, the program list page, and the A/V page, from higher to lower depths. A movement from a higher to a lower depth and a movement from a lower to a higher depth are performed via hand motions having different directionalities.

Step (a) can include further receiving information related to the multiple number of broadcast programs from the headend, including at least one of image information and program names, and the program list page can contain the images and names of programs belonging to each category.

The images of the programs within the program list page can have different sizes according to the viewership ratings or popularity of the programs.

The hand motions having different directionalities can include a zoom-in action of moving two hands closer together and a zoom-out action of moving two hands further apart.

The categories can be grouped into live programs, on-demand programs, and future programs.

The category list page, the program list page, and the A/V page can have a cyclical structure, and if a user's hand motion for moving from a higher depth to a lower depth is detected while the A/V page is outputted, then the category list page can be outputted.

The category list page and the program list page can contain a focus area, and if a selection and a movement action through the user's hand motion is detected for one of the multiple categories and multiple programs, a program list page corresponding to a selected category can be outputted or a selected program can be outputted as a full screen.

If the program list page is a page for on-demand programs, then a program option page for purchasing a selected program can be outputted according to a pre-designated hand motion of the user, and the program option page can contain one of a poster display area, an episode icon, a detailed information icon, a popular program icon, and a related live program icon.

The poster display area can be defined as a focus area, and if there is a selection of one of the plurality of icons and a movement to the focus area resulting from the user's hand motion, then a page corresponding to the selected icon can be outputted.

If the program list page is a page for future programs, then a program option page for a selected program can be outputted according to a pre-designated hand motion of the user, and the program option page can contain at least one of an image display area, a detailed information icon, a popular program icon, and a viewing reservation program icon.

The method can further include outputting a search page according to the user's request, where the search page can contain a search keyword activation area and search keyword information on a plurality of recently searched keywords. If there is a selection of one of the search keywords and a movement to the search keyword activation area via the user's hand motion, then a search result corresponding to the selected search keyword can be outputted.

Another aspect of the invention provides a method for providing broadcast service at a headend through a detection of a user's hand motions, the method comprising: (a) transmitting schedule information for a multiple number of broadcast programs and page composition information for program navigation to a broadcast receiving device; and (b) transmitting audio and video signals of a program selected by the user to the broadcast receiving device. Here, the broadcast receiving device outputs a program navigation page by using the schedule information for the broadcast programs and the composition information, if a pre-configured hand motion is detected while the selected program is outputted as a full screen. The program navigation page includes one of a category list page and a program list page, the category list page containing a plurality of categories grouped according to use time, and the program list page containing programs belonging to each category. Defining the screen outputted as a full screen as an A/V page, depths are assigned in an order of the category list page, the program list page, and the A/V page, from higher to lower depths, and a movement from a higher to a lower depth and a movement from a lower to a higher depth are performed via hand motions having different directionalities.

Still another aspect of the invention provides a method for providing broadcast service at a broadcast receiving device through a detection of a user's hand motions, the method comprising: (a) receiving schedule information for a multiple number of broadcast programs and related information from a headend, where the related information for the broadcast programs includes at least one of image information and program names; (b) outputting a home menu page for navigating programs by using the schedule information for the multiple number of broadcast programs, where the home menu page contains a plurality of categories and related information for programs belonging to each category; (c) selecting a category according to a pre-configured first hand motion of the user while the home menu page is outputted; and (d) performing navigation for programs belonging to the selected category if a pre-configured second hand motion of the user is detected after the category is selected.

Certain embodiments of the invention provide a user interface that can be easily utilized by a user through hand motions, thus enabling the user to easily navigate desired programs and select desired functions.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 illustrates a system for providing broadcast service according to an embodiment of the invention.

FIG. 2 illustrates a grip and drag action for using a broadcast service according to an embodiment of the invention.

FIG. 3 illustrates a zoom in/out action for using a broadcast service according to an embodiment of the invention.

FIG. 4 illustrates a paper action for using a broadcast service according to an embodiment of the invention.

FIG. 5 illustrates a push action for using a broadcast service according to an embodiment of the invention.

FIG. 6 illustrates a shake action for using a broadcast service according to an embodiment of the invention.

FIG. 7 illustrates a wheel action for using a broadcast service according to an embodiment of the invention.

FIG. 8 illustrates user interfaces corresponding to different depths according to an embodiment of the invention.

FIG. 9 illustrates a program list page for programs provided in a real-time format according to a first example of an embodiment of the invention.

FIG. 10 illustrates a program list page for programs provided in an on-demand format according to the first example of an embodiment of the invention.

FIG. 11 illustrates a program list page for programs provided in the future according to the first example of an embodiment of the invention.

FIG. 12 illustrates an on-demand program option page according to the first example of an embodiment of the invention.

FIG. 13 illustrates an episode list page according to the first example of an embodiment of the invention.

FIG. 14 illustrates a detailed information page for an on-demand program according to the first example of an embodiment of the invention.

FIG. 15 illustrates an option page for a future program according to the first example of an embodiment of the invention.

FIG. 16 illustrates a detailed information page for a future program according to the first example of an embodiment of the invention.

FIG. 17 illustrates a popular program page associated with a future program according to the first example of an embodiment of the invention.

FIG. 18 illustrates a genre list page according to the first example of an embodiment of the invention.

FIG. 19 illustrates different functions being called according to various hand motions of the user in an A/V page according to the first example of an embodiment of the invention.

FIG. 20 illustrates a live program viewing option page according to the first example of an embodiment of the invention.

FIG. 21 illustrates a related live program list page according to the first example of an embodiment of the invention.

FIG. 22 illustrates a detailed information page for a live program according to the first example of an embodiment of the invention.

FIG. 23 illustrates an on-demand program section navigation page according to the first example of an embodiment of the invention.

FIG. 24 illustrates a pause state according to the first example of an embodiment of the invention.

FIG. 25 illustrates a volume adjustment procedure according to the first example of an embodiment of the invention.

FIG. 26 illustrates a recently viewed program list according to the first example of an embodiment of the invention.

FIGS. 27A and 27B illustrate a voice search page according to the first example of an embodiment of the invention.

FIG. 28 illustrates a search result page according to the first example of an embodiment of the invention.

FIG. 29 illustrates a home menu page according to a second example of an embodiment of the invention.

FIG. 30A and FIG. 30B illustrate a program navigation procedure according to the second example of an embodiment of the invention.

FIG. 31 illustrates a viewing option page according to the second example of an embodiment of the invention.

FIG. 32 illustrates a recently viewed program list page according to the second example of an embodiment of the invention.

FIG. 33 illustrates a popular live program list page according to the second example of an embodiment of the invention.

FIG. 34 illustrates a popular on-demand program list page according to the second example of an embodiment of the invention.

FIG. 35 illustrates an all channel list page according to the second example of an embodiment of the invention.

FIG. 36 illustrates a volume adjustment procedure according to the second example of an embodiment of the invention.

FIG. 37 illustrates a section navigation procedure according to the second example of an embodiment of the invention.

FIG. 38 illustrates a screen being outputted when a flick in an up-down direction is detected during the playing of an on-demand program according to the second example of an embodiment of the invention.

FIG. 39 illustrates the screen that is outputted when an up-down flick by the user is detected in FIG. 38.

FIG. 40 illustrates a supplementary information indicator being displayed according to the second example of an embodiment of the invention.

FIG. 41 illustrates the detailed composition of a broadcast receiving device according to an embodiment of the invention.

### DETAILED DESCRIPTION

As the present invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In describing the drawings, like reference numerals are used for like elements. Certain embodiments of the invention will be described below in more detail, with reference to the accompanying drawings.

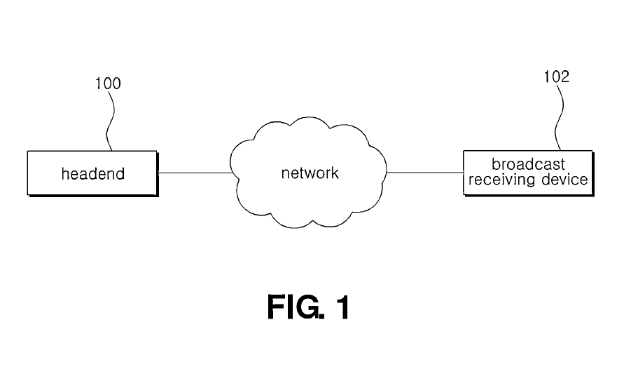

FIG. 1 illustrates the composition of a system for providing broadcast service according to an embodiment of the invention.

As illustrated in FIG. 1, a system for providing broadcast service according to this embodiment can include a headend 100 and a broadcast receiving device 102 connected with the headend 100 over a network.

The headend 100 may provide a live program or an on-demand program according to a preconfigured schedule.

The headend 100 may convert the audio and video signals (AV signals) for various broadcast channels into a preconfigured format, and transmit the converted broadcast signals to the broadcast receiving device 102.

Also, the headend 100 can be equipped with a separate communication server (e.g. a return path server) for processing the user's requests through a return channel, to provide Internet services and various communication services.

Furthermore, the headend 100 can transmit schedule information for programs provided currently or in the future as well as on-demand programs to the broadcast receiving device 102, where the schedule information can be updated periodically.

Moreover, sets of related information for the broadcast programs can be provided as well.

Here, the related information for the broadcast programs can include a related image, program name, channel name, synopsis, broadcast time, playing time, cast, viewership ratings information, etc., of each program.

A related image of a program can be a real-time image in the case of a live program, a poster in the case of an on-demand program, and a representative image in the case of a program provided in the future.

The descriptions that follow will be provided mainly for examples in which the poster and representative image are still images related to an on-demand program or a future program. However, the invention is not thus limited, and the poster and representative image can also include a video clip, such as one showing the highlights of the program.

The broadcast receiving device 102 according to this embodiment can receive broadcast signals from the headend 100 and decode the broadcast signals. The broadcast receiving device 102 encompasses any terminal that is capable of outputting a program guide according to the schedule information.

The broadcast receiving device 102 according to this embodiment can be a typical TV set or a set-top box, but is not thus limited, and encompasses the smart phone, tablet PC, desktop PC, etc., capable of receiving broadcast signals.

The descriptions that follow will be provided using examples in which the broadcast receiving device 102 is assumed to be a set-top box.

According to an embodiment of the invention, the broadcast receiving device 102 may detect a user's hand motion and provide a service corresponding to the detected hand motion.

A service associated with an embodiment of the invention can be for program navigation, which allows the user to select one a program from a multiple number of programs by way of a particular user interface (UI), as well as for providing supplementary information related to a selected program and for selecting another option (e.g. play, pause, navigate another section, etc.) while viewing the program.

According to an embodiment of the invention, the UI provided by the broadcast receiving device 102 may be composed such that the user can take advantage of the program navigation and various other services simply with hand motions.

A process for providing broadcast service based on the user's hand motion is described below, divided into a first example and a second example.

### (1) First Example

According to a first example of an embodiment of the invention, a multiple number of pages for program navigation and option selection may be generated using the schedule information and program related information. When a pre-designated hand motion by the user is detected, the broadcast receiving device 102 may consider the output currently on the screen and correspondingly output a program navigation page or an option page.

According to an embodiment of the invention, the composition information for generating the page can be provided beforehand from the headend 100.

Preferably, the multiple number of program navigation pages and option pages can have different depths, and when the user's hand motion is detected, the broadcast receiving device 102 may output a page corresponding to a lower depth from a higher depth or a page corresponding to a higher depth from a lower depth.

Here, the user's hand motion for moving from a higher depth to a lower depth and the user's hand motion for moving from a lower depth to a higher depth can be actions having different directionalities.

According to the first example of an embodiment of the invention, the services that can be provided through hand motion detection can include outputting a category list page, outputting a program list page corresponding to the category of the program currently being used, outputting an A/V (audio/video) page displaying a live program when a program is selected from the program list page, and outputting a program option page for an on-demand program or a program that is to be provided in the future. Also, function option pages can be included such as for browsing genres, selecting a viewing option, performing a search, adjusting volume, etc., and a provision for returning to the previous state can be included as well.

In an embodiment of the invention, the hand motions can be designated as follows:

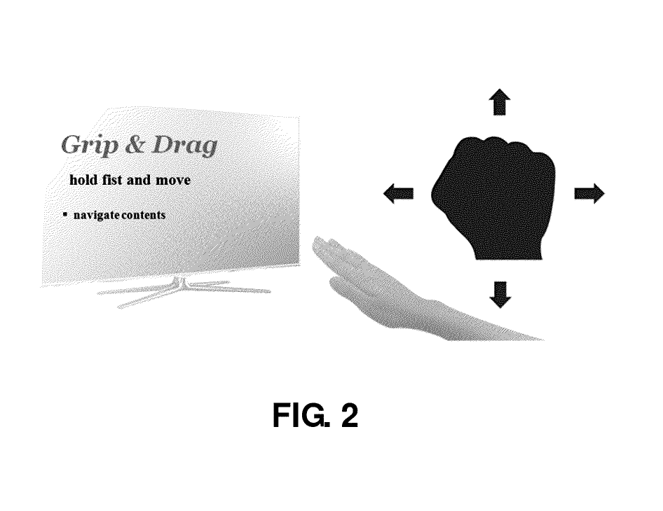

1) Grip & Drag: from an open hand, holding a first and moving (see FIG. 2).

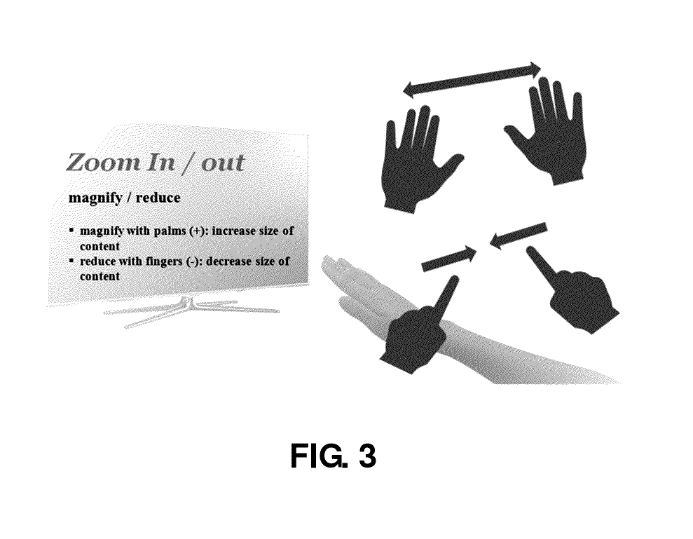

2) Zoom In/Out: increasing or decreasing the distance between both hands (see FIG. 3). To clearly differentiate a zoom-in from a zoom-out, the zoom-in action can be defined as increasing the distance between both palms, and the zoom-out action can be defined as decreasing the distance between two fingers. Of course, the invention is not thus limited.

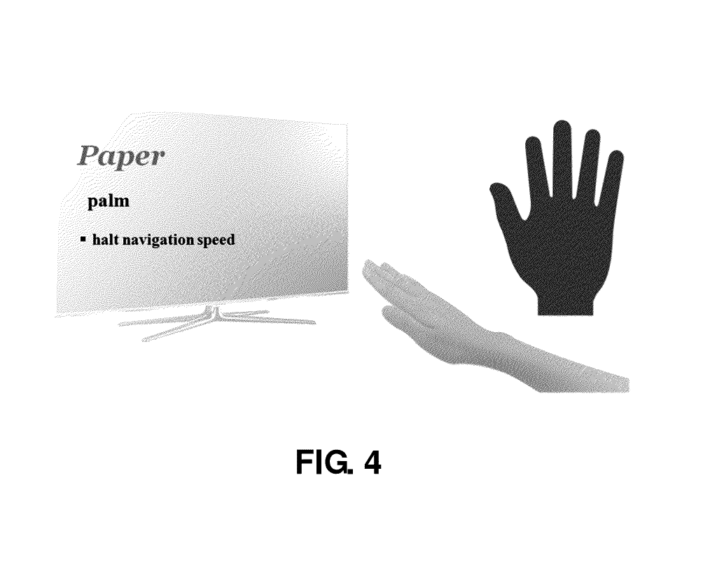

3) Paper: holding a palm open towards the screen and keeping still for a certain amount of time (see FIG. 4)

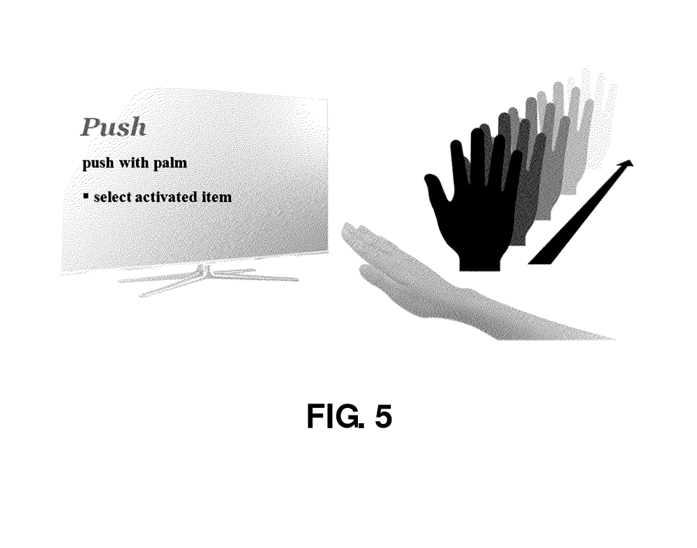

4) Push: with an open hand, pushing in a direction orthogonal to the screen (see FIG. 5)

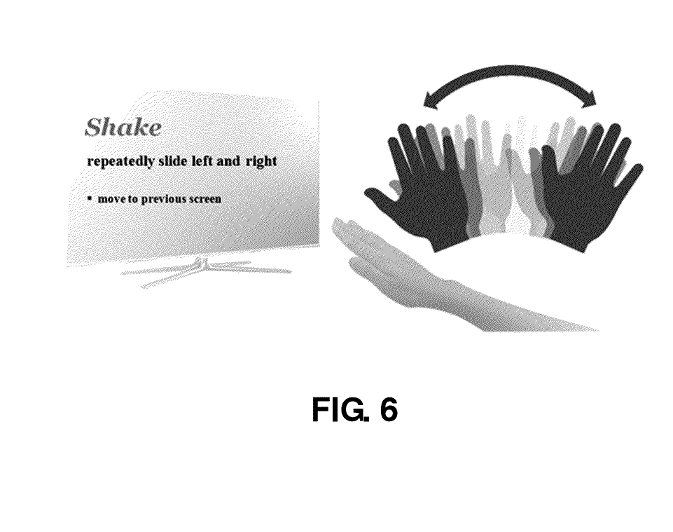

5) Shake: shaking a hand (open hand) left and right (see FIG. 6)

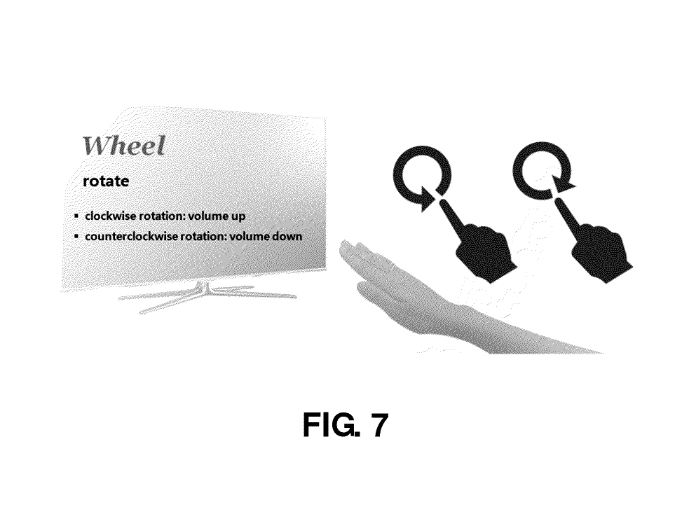

6) Wheel: rotating with a palm or a finger (see FIG. 7)

7) Grip: from an open hand, making a fist

8) Flick: quickly moving a palm in a particular direction

According to an embodiment of the invention, the services related to the user's use of broadcast programs can be classified mainly into navigate, call/select/cancel function, and adjust volume types, and the hand motions described above can be assigned to one of the three types as in the table shown below.

TABLE 1
Types of Hand Motions

| Service | Hand Motion |
|---|---|
| Navigate | Grip & Drag |
| | Zoom In/Out |
| Call/Select/Cancel | Grip |
| Function | Paper |
| | Push |
| | Shake |
| | Flick |
| Volume | Wheel |

According to an embodiment of the invention, the Grip & Drag action can be used for: navigating a category within a category list page, navigating a genre within a genre list page, navigating an option within a program option page, navigating a subsequent episode within the program options for a serial, scrolling within the detailed information of a program, navigating a subsequent episode for a popular program, section navigation within an on-demand program, navigating search keywords, and navigating a recently viewed program.

That is, the Grip & Drag action according to an embodiment of the invention may be used for selecting a program from multiple programs in different UI's, navigating different programs, and the like.

The UI's for the category list, genre list, program list, and program options according to an embodiment of the invention will be described later on in more detail.

The Zoom In/Out action according to an embodiment of the invention may be used for navigation, similar to the Grip & Drag.

However, whereas the Grip & Drag action may be used mainly for selecting a program from a multiple number of programs, the Zoom In/Out may be used for moving to an adjacent depth.

Here, the Zoom In action may be used for moving to a UI corresponding to a lower depth from a higher depth, while the Zoom Out action may be used for moving to a UI corresponding to a higher depth from a lower depth.

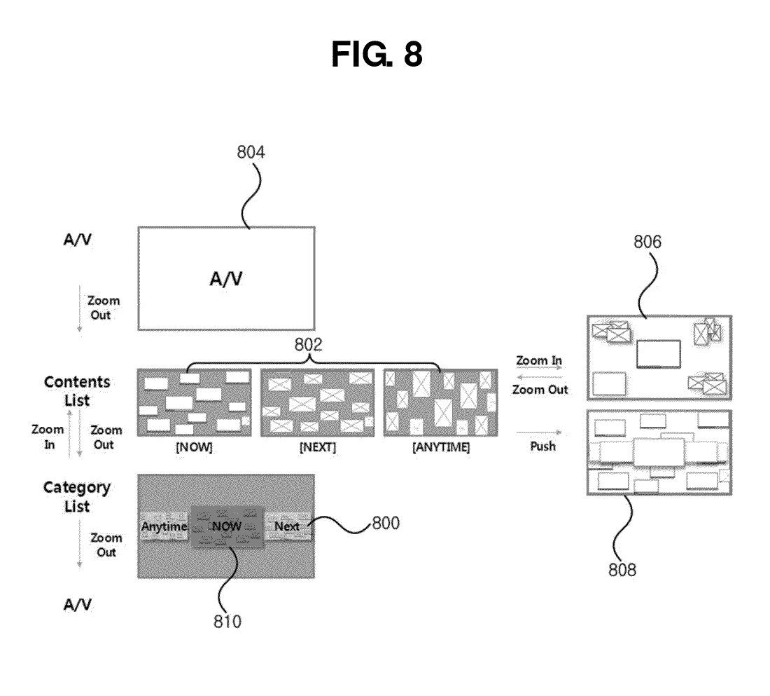

FIG. 8 illustrates user interfaces corresponding to different depths according to a first example of an embodiment of the invention.

As illustrated in FIG. 8, the UI's according to an embodiment of the invention can include program navigation pages, such as a category list page 800 and program list pages 802, an A/V page 804, and a program option page 806.

Here, the category list page may correspond to a higher depth compared to the program list page, while the program list page 802 may correspond to a higher depth compared to the A/V page 804 and the program option page 806.

The A/V page 804, described below in more detail, is the page in which a program selected by the user is outputted as a full screen.

The program option page 806 is a page relating to the on-demand or future program category. In the case of an on-demand program, if the user completes a purchase or enters a play request, the program option page 806 may switch to the A/V page 804.

That is, the A/V page 804 and the program option page 806 can be defined to have the same depth.

In an embodiment of the invention, the categories can be grouped according to use time into live programs (NOW), on-demand programs (ANYTIME), and future programs (NEXT).

A category list page 800 according to an embodiment of the invention may provide information related to live programs, on-demand programs, and future programs.

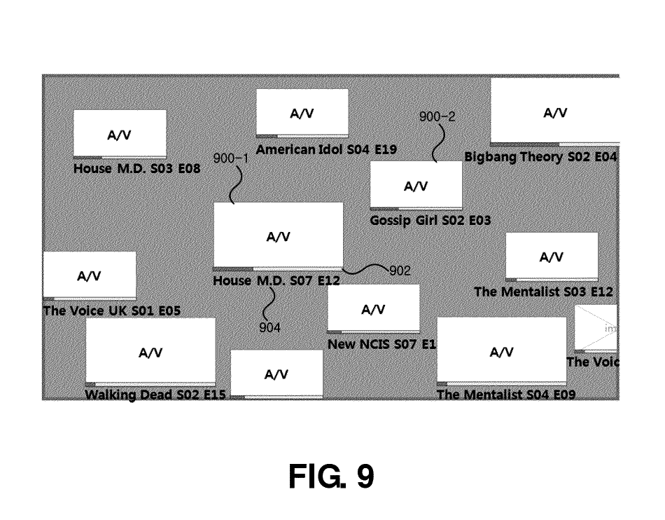

FIG. 9 through FIG. 11 illustrate pages corresponding to different categories, in an embodiment of the invention.

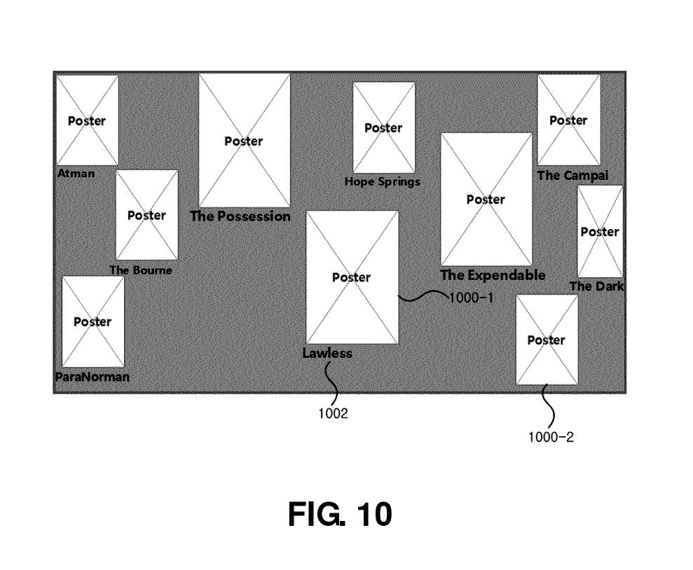

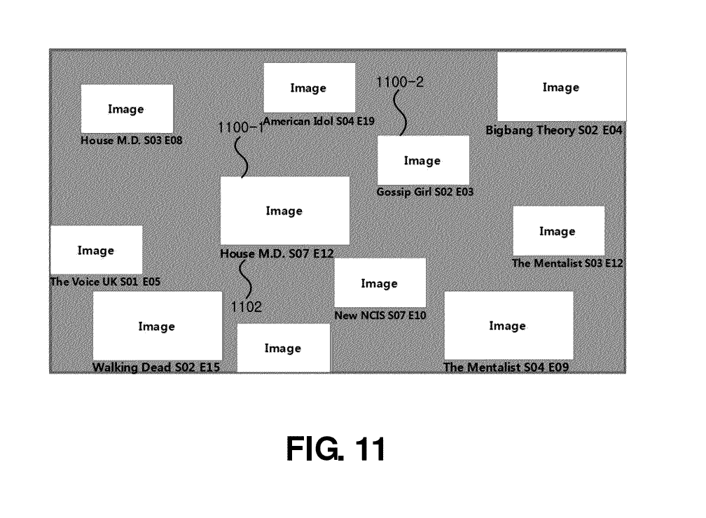

That is, FIG. 9 illustrates a program list page for programs provided in a live format according to a first example of an embodiment of the invention, FIG. 10 illustrates a program list page for programs provided in an on-demand format, and FIG. 11 illustrates a program list page for programs that are to be provided in the future.

As illustrated in FIG. 8, a category list page according to an embodiment of the invention may include a focus area 810 located at the center. A user may make a grip action at the position of a desired category and drag it to the focus area 810, responding to which the broadcast receiving device 102 may move the category selected by the user to the focus area 810.

When one of the three categories is selected and moved to the focus area 810, the selected category can be shown enlarged.

Afterwards, when the user zooms in to the category displayed in the focus area 810, then a program list corresponding to the category selected by the user may be outputted magnified, as shown in FIGS. 9 to 11. That is, the broadcast receiving device 102 may detect the user's zoom-in action to move from a higher depth to a lower depth.

In the following, a description of the program list page is provided, with reference to FIGS. 9 to 11, followed by a description of the movement to the A/V page 804 and the program option page 806 by way of a zoom-in from the program list page.

As illustrated in FIGS. 9 to 11, a program list page according to an embodiment of the invention may display information (image and program name) related to the multiple number of programs corresponding to each category. Here, the image can be defined differently according to category, for example as a live image, a poster, and a representative image.

As illustrated in FIG. 9, the program list page for the live program (NOW) category can display real-time image information 900-1 and 900-2, progress bar information 902, and program name information 904 for each program.

Here, the real-time image information may include the image currently provided in real time on each channel, preferably a video clip converted to a low resolution, without necessarily outputting the audio.

According to an embodiment of the invention, the program list page for live programs can display the real-time images in different sizes according to the viewership ratings of the programs.

For example, the broadcast receiving device 102 can adjust the output such that, from among the live programs, the real-time images 900-1 of programs having viewership ratings within a predetermined ranking are larger, while the real-time images 900-2 of other programs are smaller.

Thus, the user can intuitively identify which programs are currently being viewed by many users.

As illustrated in FIG. 10, the program list page for the on-demand (ANYTIME) category can display poster information 1000 and program name information 1002 for each program.

According to an embodiment of the invention, the poster sizes in the program list page for on-demand programs can be set differently according to the popularity of the programs.

For example, from among the on-demand programs, the posters 1000-1 of programs having popularity rankings within a predetermined ranking can be displayed larger, while the posters 1000-2 of other programs can be displayed smaller.

Here, the popularity does not necessarily have to be a purchase ranking, but can also be a value obtained from the evaluation of users who have watched the program.

As illustrated in FIG. 11, the program list page for the future program (NEXT) category can display a representative image 1100 and a program name for each program.

Preferably, the program list page for future programs can include a subsequent episode of a serial, of which an episode has been provided already.

In cases where the future programs are forthcoming episodes of serials, the broadcast receiving device 102 can output the representative images with different sizes determined based on the viewership ratings of the previous episodes of the respective programs.

For example, the broadcast receiving device 102 may determine the sizes of the representative images in consideration of the ratings of the immediately prior episodes or the average ratings of a predetermined number of previous episodes, and thus output representative images of differing sizes (see reference numerals 1100-1 and 1100-2).

In such type of program list page, the user may position his/her hands over a program and perform the Zoom In action, to move to the A/V page 804 or the program option page 806.

That is, a zoom-in at the program list page may mean moving to a page corresponding to a lower depth.

According to an embodiment of the invention, when a Zoom In action is detected, the broadcast receiving device 102 may perform a movement to a different lower depth according to the category of the program currently being outputted.

If a Zoom In is detected at the program list page for live programs, such as that in FIG. 9, the broadcast receiving device 102 may directly sync with the channel of the corresponding live program and output it as a full screen. That is, if a Zoom In is detected at the program list page for live programs, the broadcast receiving device 102 may output the A/V page 804 of FIG. 8.

On the other hand, if a Zoom In is detected at the program list page for on-demand or future programs, such as those in FIG. 10 and FIG. 11, the program option page 806 may be outputted.

According to an embodiment of the invention, when a Zoom Out action is detected while the A/V page 804 or the program option page 806 is being outputted, the broadcast receiving device 102 may output the program list page 802 corresponding to a higher depth.

According to an embodiment of the invention, if the A/V page 804 was being outputted before the Zoom Out action, then the broadcast receiving device 102 may output the program list page for the live programs category, and if the program option page 806 was being outputted, then the program list page for the on-demand programs or future programs category may be outputted.

Also, if the user's Zoom Out action is detected during the output of a program list page, the broadcast receiving device 102 may output the category list page, such as that illustrated in FIG. 8, as it corresponds to a higher depth.

In the foregoing, the Zoom In action is described as moving from a higher to a lower depth, and the Zoom Out action is described as moving from a lower to a higher depth.

According to an embodiment of the invention, while the A/V page 804 is being outputted, the Zoom Out action can be used for moving from a higher depth to a lower depth.

For example, while the A/V page 804 is outputted, the Zoom Out action can be performed consecutively to arrive at the category list page 800, and if the user performs the Zoom Out action again, the broadcast receiving device 102 may output the A/V page 804 again.

That is, in situations where the user is viewing a live program, the A/V page 804, program list page 802, and category list page 800 can have a cyclical structure, such that a Zoom Out action performed at the category list page 800 may be used as a command to return to the adjacent A/V page 804.

The return to the A/V page 804 can also be performed by the user's Shake action.

A description is provided below, with reference to the accompanying drawings, of the process for providing broadcast service through user hand motion detection, when the program option page is being outputted.

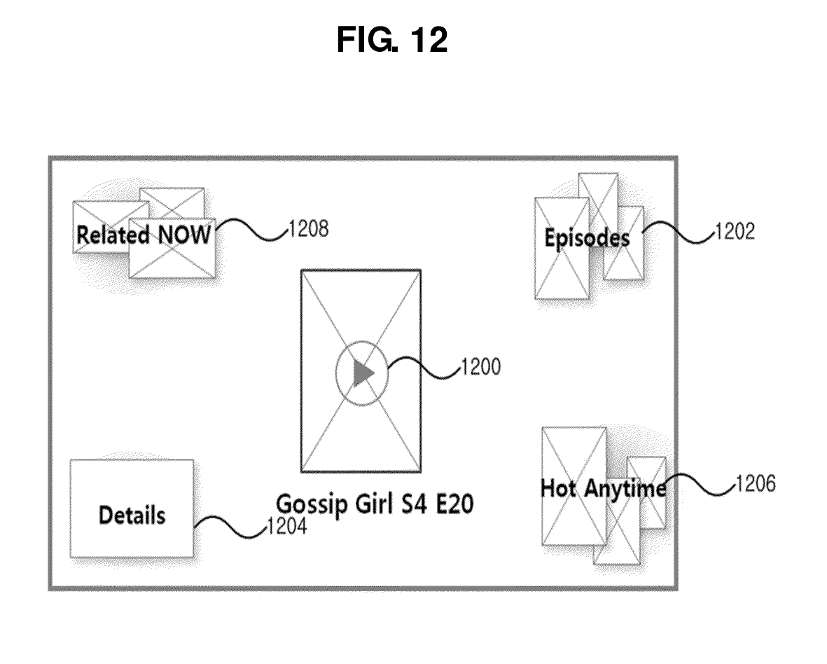

FIG. 12 illustrates an on-demand program option page according to an embodiment of the invention.

If the user's Zoom In action is detected at the program list page for the on-demand programs category, the broadcast receiving device 102 may output the program option page for the on-demand program.

According to an embodiment of the invention, a Zoom In action within the program list page can be recognized as an action for selecting a particular program. If the user brings one of the programs included in the program list page into focus and then performs a Zoom In action, the broadcast receiving device can recognize this as a selection of the program. The same can apply in the case of pages for live programs and future programs.

As illustrated in FIG. 12, a program option page for an on-demand program according to an embodiment of the invention can include a poster display area 1200, an episode icon (Episodes) 1202, a detailed information icon (Details) 1204, a popular program icon (Hot Anytime) 1206, and a related live program icon (Related Now) 1208.

The poster display area 1200 can display a poster and the program name for the on-demand program selected by the user by a Zoom In action from the on-demand program list page.

Such poster display area 1200 may be positioned in the center of the on-demand program option page. In an embodiment of the invention, the center position of each page may be defined as a focus area.

According to an embodiment of the invention, a multiple number of icons 1202-1208 may be positioned around the poster display area 1200, and if the user grips one of the icon groups and drags it to the center position (focus area), then a page corresponding to the selected icon may be outputted.

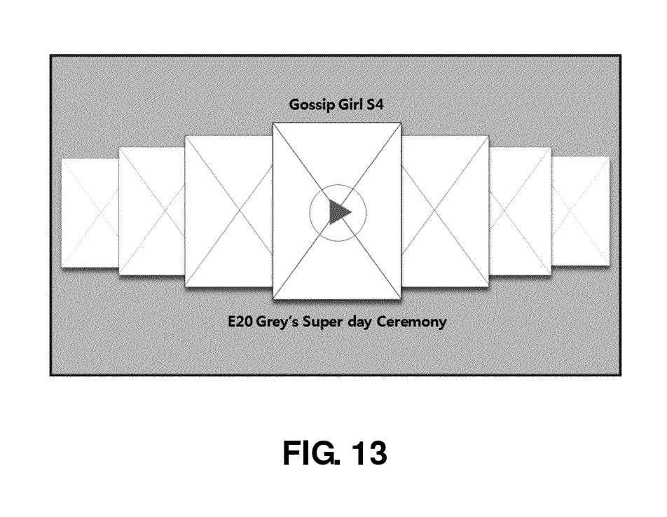

Here, the episode icon 1202 may be an icon that is activated or displayed if the on-demand program selected by the user is a serial. If the episode icon 1202 is gripped and dragged to the focus area, an episode list page such as that shown in FIG. 13 may be outputted. This episode list page can also be defined as a program navigation page according to an embodiment of the invention and may correspond to a lower depth of the on-demand program option page.

As illustrated in FIG. 13, an episode list page according to an embodiment of the invention may include a poster focused in the center, with other posters gradually decreasing in size as represented in a perspective view on either side.

Preferably, in the episode list page, the poster focused in the center may be related to the most recent episode in the serial, and the posters for other episodes may be aligned sequentially on the left and right. Preferably, the right side may be empty in the initial screen, the poster for the most recent episode may be shown in the center, and the posters for previous episodes may be aligned in order on the left.

If a Zoom In action by the user is detected for the poster arranged in the center, the broadcast receiving device 102 may output a page for playing or purchasing the on-demand program.

If a selection is made for playing or purchasing an on-demand program, then the icons may be removed, and the on-demand program may be outputted as a full screen.

The navigating of other episodes can be performed by gripping the poster for another episode and dragging it to the focus area.

The detailed information icon 1204 may be an icon for providing detailed information on the on-demand program selected by the user.

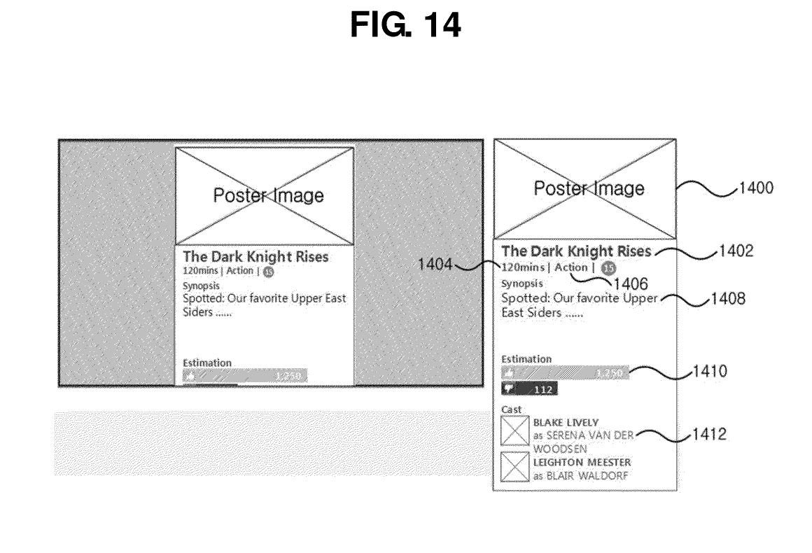

If a Grip & Drag action is applied on the detailed information icon 1204, the broadcast receiving device 102 may output a detailed information page such as that shown in FIG. 14.

As illustrated in FIG. 14, a detailed information page for an on-demand program according to an embodiment of the invention can display detailed information such as the poster 1400, program name 1402, playing time 1404, genre 1406, synopsis 1408, user evaluation information 1410, and cast information 1412.

The detailed information page can include much information, and the user can employ the Grip & Drag action for scrolling, to see the information displayed on the initial page as well as the remaining information positioned below the bottom.

That is, scrolling may be implemented by gripping and then dragging downwards or upwards.

The popular program icon 1206 may be an icon for providing information related to programs having high popularity. The live program icon 1208 may be an icon for providing information on live programs that correspond to the same genre as that of the on-demand program selected by the user.

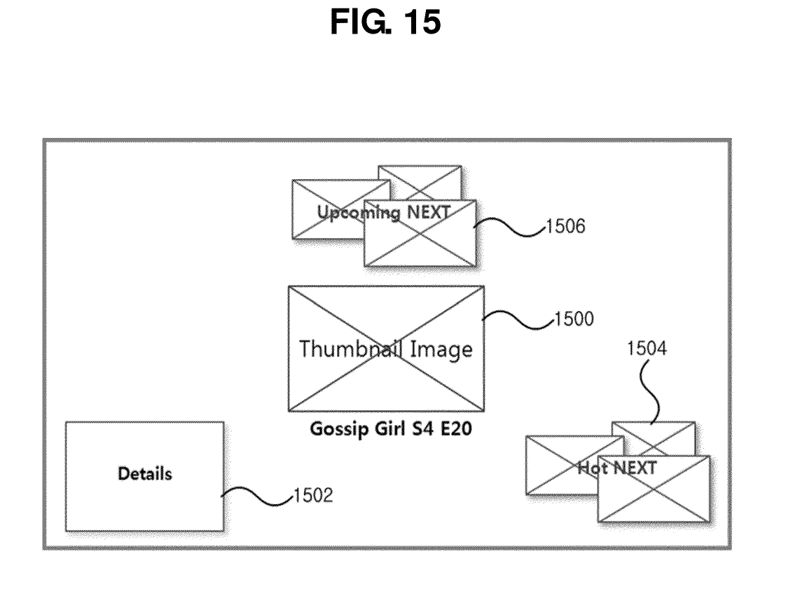

FIG. 15 illustrates an option page for a future program according to the first example of an embodiment of the invention.

A future program option page according to an embodiment of the invention may be outputted when a Zoom In action is detected at the program list page for the future programs category.

As illustrated in FIG. 15, a future program option page according to an embodiment of the invention can include a thumbnail display area 1500, a detailed information icon (Details) 1502, a popular program icon (Hot NEXT) 1504, and a viewing reservation program icon (Upcoming NEXT) 1506.

The thumbnail display area 1500 may be positioned at the center of the future program option page, and the thumbnail display area 1500 may display a thumbnail image, together with the program name.

According to an embodiment of the invention, if the user's Zoom In action for the thumbnail display area 1500 is detected, the broadcast receiving device 102 may set a viewing reservation for the selected program.

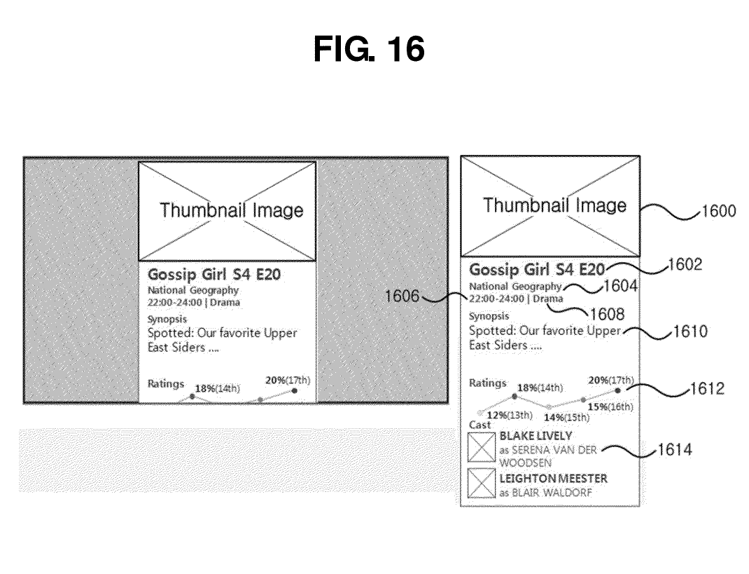

If the detailed information icon 1502 is gripped and dragged to the focus area where the thumbnail image is displayed, then the detailed information for the program corresponding to the thumbnail image may be outputted, as shown in FIG. 16.

Referring to FIG. 16, the detailed information page for a future program can include a thumbnail image 1600, program name 1602, channel name 1604, starting and ending times 1606, genre 1608, synopsis 1610, viewership ratings 1612 of previous episodes, and cast information 1614.

Here, if the future program is a serial, the viewership ratings 1612 of previous episodes may be displayed. In one example, the viewership ratings 1612 can include the ratings of the past five episodes.

The popular program icon 1504 may be an icon for providing popular programs from among the programs that are planned to be broadcast within a particular period from the present.

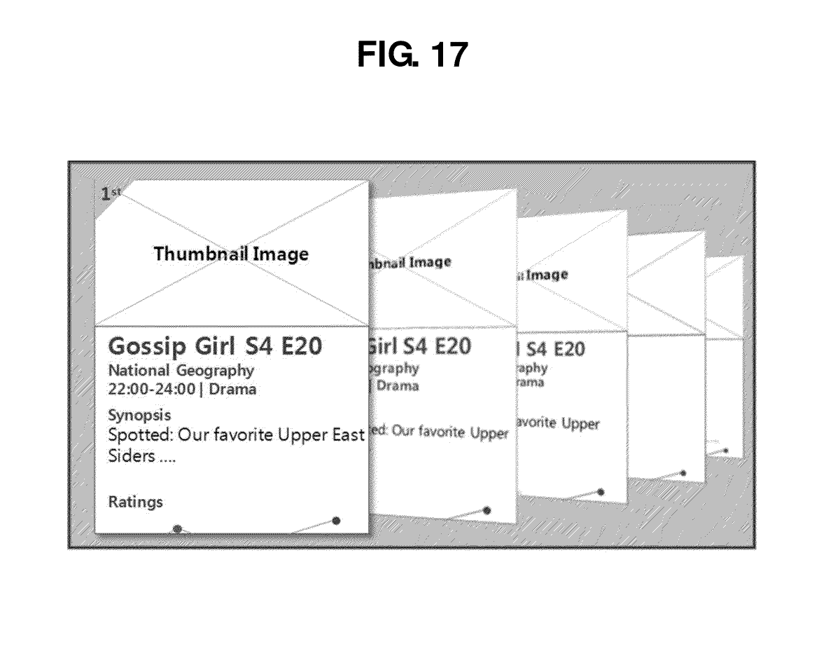

If there is a Grip & Drag action of the popular program icon 1504 in the future program option page, then a popular program page such as that illustrated in FIG. 17 may be outputted.

Referring to FIG. 17, a popular program page may display detailed information, as in FIG. 16, on multiple popular programs.

For example, the popular program page can include detailed information on a particular number (e.g. 10 to 20) of future programs of which previous episodes had the highest viewership ratings.

A popular program page according to an embodiment of the invention can be provided in a 3D format, and from among the multiple number of future programs, the detailed information of the program of which the previous episodes had the highest viewership ratings can be arranged at the top, with respect to a direction orthogonal to the screen.

The user can navigate the future programs having the next highest viewership ratings by using the Grip & Drag action.

In the foregoing, a detailed description is provided of a process for controlling broadcast services by the Grip & Drag and Zoom In/Out actions.

The following describes types of hand motions for calling/selecting/canceling functions and a control process employing such hand motions.

According to an embodiment of the invention, if a Push is detected while a program list page 802 is being outputted, such as that illustrated in FIG. 8, then a genre list page 808 may be outputted.

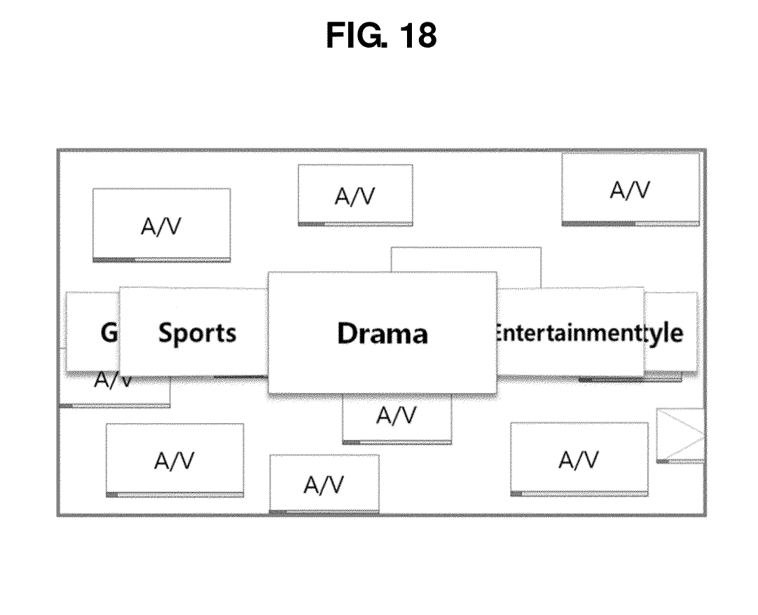

FIG. 18 illustrates a genre list page according to the first example of an embodiment of the invention.

As illustrated in FIG. 18, a genre list page 808 according to an embodiment of the invention may include information for a multiple number of genres. The center position may be the focus area, and the user can move a genre to the focus area by using a Grip & Drag action.

According to an embodiment of the invention, if a genre is selected in the genre list page 808, the broadcast receiving device 102 may output information related to programs belonging to the selected genre, in the background of the genre information.

Here, the information related to programs belonging to each genre can be grouped according to category, where the program related information may be as illustrated in FIGS. 9 to 11.

A Push action according to an embodiment of the invention can be used as for selecting, in addition to changing from a program list page 802 to a genre list page 808 as described above.

For example, if a Push action on the focus area is detected in the category list page 800, then the broadcast receiving device 102 may output the program list page 802 of the corresponding category, similar to the case of the Zoom In action.

If a Push is made on the focus area of the on-demand program option page, the broadcast receiving device 102 may output a page for playing or purchasing the program.

Also, if a Push action is detected on the focus area in the future program option page, a viewing reservation can be made, similar to the case of the Zoom In action.

According to an embodiment of the invention, the Grip, Paper, Push, Shake, and Flick actions may be used for calling/selecting/cancelling particular functions when a particular page is outputted.

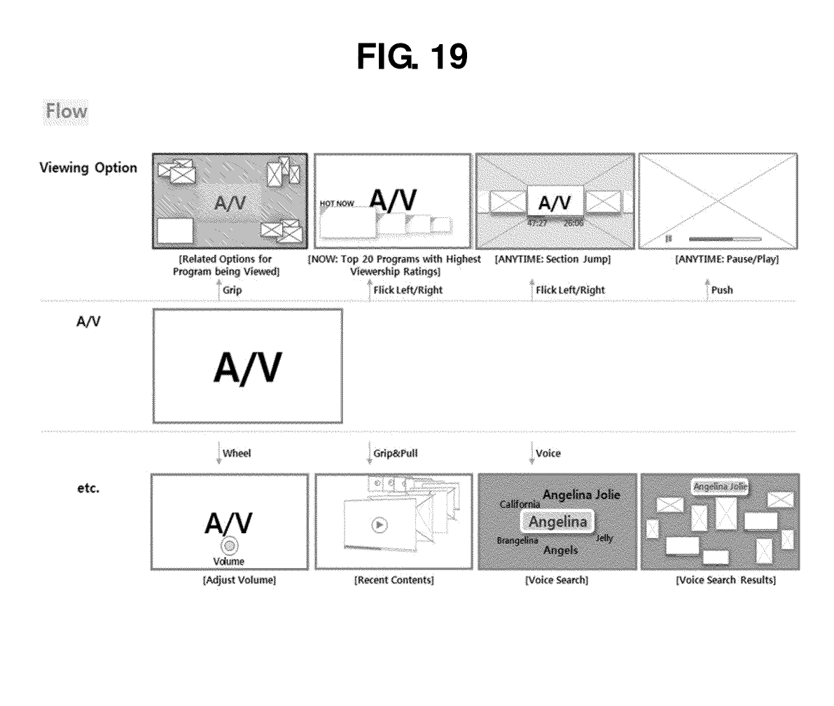

FIG. 19 illustrates different functions being called according to various hand motions of the user in an A/V page according to the first example of an embodiment of the invention.

A detailed description is provided below, with reference to the accompanying drawings, of how each function may be called. For convenience, the screen that appears when a particular function is called is defined as a page.

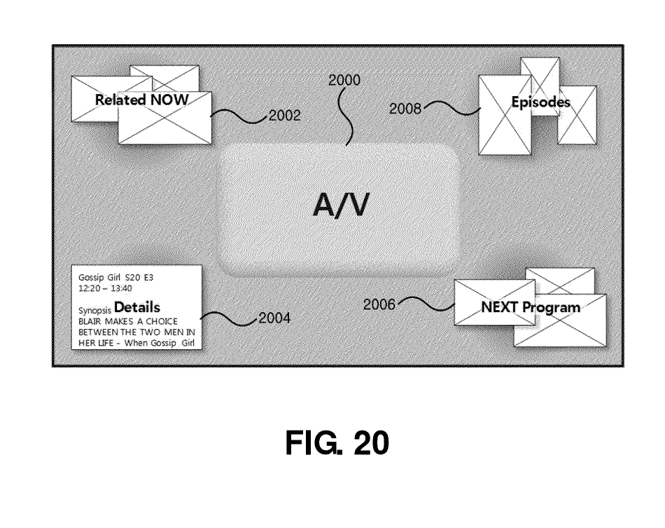

FIG. 20 illustrates a live program viewing option page according to the first example of an embodiment of the invention.

A live program viewing option page 1900 such as that shown in FIG. 20 may be outputted when a Grip action by the user is detected while the user is viewing a live program through the A/V page 804.

As illustrated in FIG. 20, the live program viewing option page can include a live image display area 2000, a related live program icon (Related Now) 2002, a detailed information icon 2004, a future program icon 2006, and an episode icon 2008.

When the user's Grip action is detected during the output of a live program on the full screen, the broadcast receiving device 102 may convert the live program being watched by the user into a smaller size and output it in the live image display area 2000, and may output the icons 2002-2008 described above around the live image display area.

If the user grips one of the icons and drags it to the focus area, the broadcast receiving device 102 may output a page corresponding to the selected icon.

The related live program icon (Related Now) 2002 may be an icon for providing programs that are of the same genre as the live program currently being viewed.

The future program icon 2006 may be an icon for providing a list of programs that will be provided at later times on the channel currently being viewed, and the episode icon 2008 may be an icon for providing a list of other episodes if the program currently being viewed is a series.

The future program list and the episode list can be provided in the manner of FIG. 13 or FIG. 17.

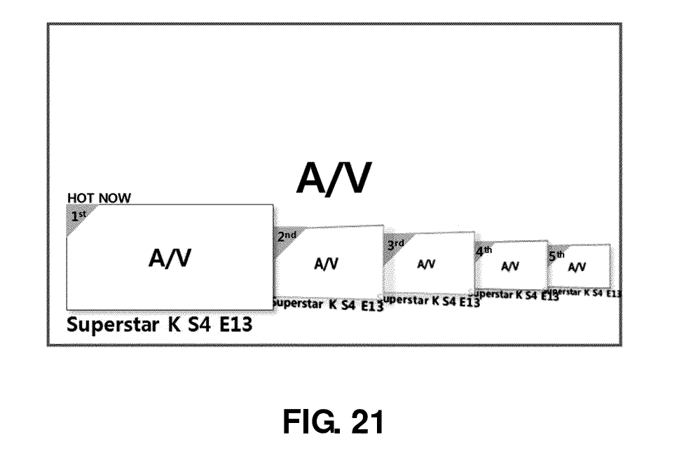

FIG. 21 illustrates a related live program list page according to the first example of an embodiment of the invention.

As illustrated in FIG. 21, a related live program list according to an embodiment of the invention can include the live images and program names of live programs which belong to the same genre as the current program and of which the viewership ratings are within a particular ranking.

Preferably, the sizes of the live images in the live program list can be determined according to the viewership rating rankings. Preferably, the live images having higher ratings can be displayed on the left, and the other live images can be displayed subsequently with gradually decreasing sizes.

The user can navigate a desired program by using the Grip & Drag action.

Here, if the user performs a Zoom In to a program, the broadcast receiving device 102 may interpret this as a selection of the program, to sync with the channel of the corresponding live program and output it as a full screen.

Here, the user's Push action can also be recognized as a selection of the program, similar to the Zoom In.

According to an embodiment of the invention, if a Flick action by the user is detected while in the A/V page 804, the broadcast receiving device 102 can output a related live program list such as that shown in FIG. 21.

If the user grips the detailed information icon 2004 and drags it to the focus area, a detailed information page may be outputted.

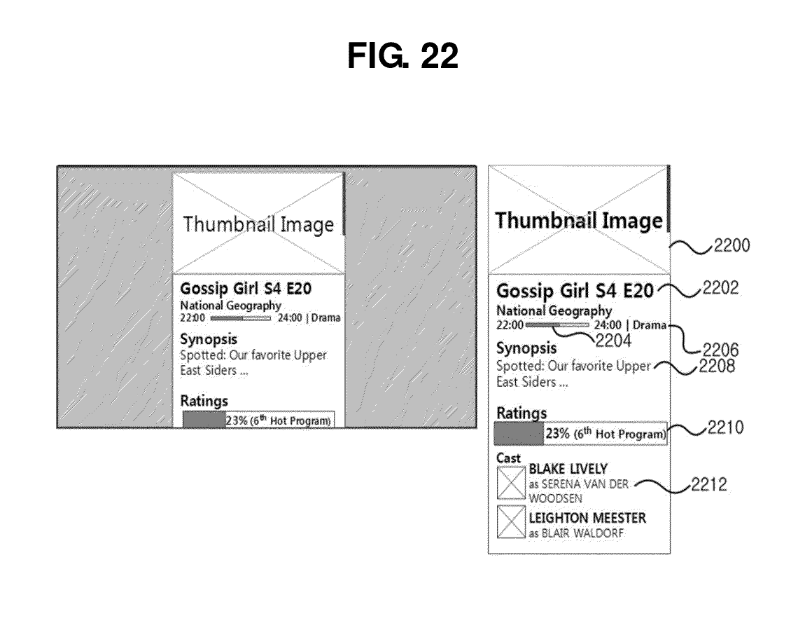

FIG. 22 illustrates a detailed information page for a live program according to the first example of an embodiment of the invention.

As illustrated in FIG. 22, a detailed information page for a live program according to an embodiment of the invention can include a program thumbnail 2200, the program name 2202, the starting and ending times and a progress bar 2204, the genre 2206, synopsis 2208, viewership ratings and ratings ranking information 2210, and cast information 2212.

The user can scroll the detailed information page by using the Grip & Drag action.

In the foregoing, it is explained that, if a Grip action is detected during the viewing of a live program, the viewing option page may be outputted.

According to an embodiment of the invention, if the user's Grip action is detected while the program currently being viewed is an on-demand program, then the broadcast receiving device 102 can output an on-demand program option page such as that of FIG. 12.

Referring again to FIG. 19, in the case where the program currently being viewed is an on-demand program, if the user's Flick action is detected, then the broadcast receiving device 102 may output a page for section navigation of the on-demand program.

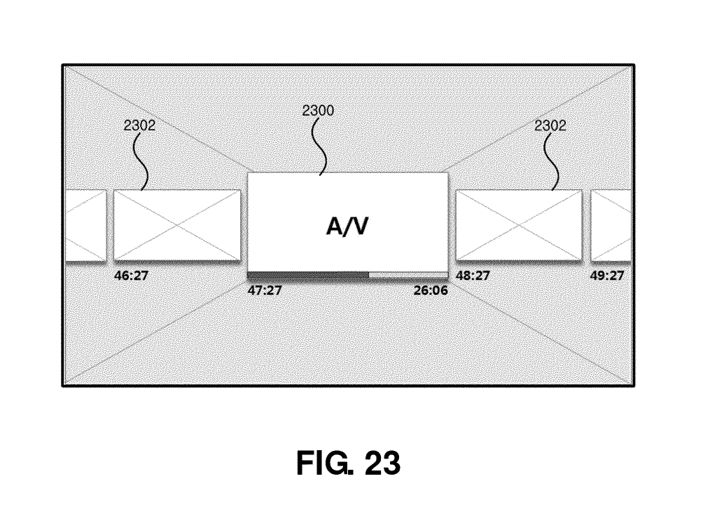

FIG. 23 illustrates an on-demand program section navigation page according to the first example of an embodiment of the invention.

As illustrated in FIG. 23, an on-demand program section navigation page can include an image display area 2300 and one or more thumbnails 2302.

The image display area 2300 may output the on-demand program currently being viewed, and may display a progress bar, the playing time, and the play remaining time.

In addition to this, thumbnails of the sections before and after the current section may be displayed in a surrounding part of the image display area 2300.

Here, the thumbnail of the section prior to the currently playing section can be displayed on the left, and the thumbnail of the section following the currently playing section can be displayed on the right. For example, the thumbnails can have 1-minute, 3-minute, or 5-minute intervals from the currently playing section.

If the user makes a Grip & Drag action on one of the multiple thumbnails and moves it to the image display area (focus area) 2300, then the on-demand program of the corresponding section may be outputted.

Such selecting of the thumbnail can also be implemented by a Push action.

If the user wishes to navigate a section other than those represented by the thumbnails displayed on the current screen, the user may perform a Flick action or may perform a Grip and then Drag to the left or right instead of the focus area, and the broadcast receiving device 102 may output thumbnails of other sections.

Here, if the navigation is performed as above, the multiple number of thumbnails may move left or right while displayed on the screen, and if the user's Paper action is detected, the broadcast receiving device 102 may stop the movement of the thumbnails.

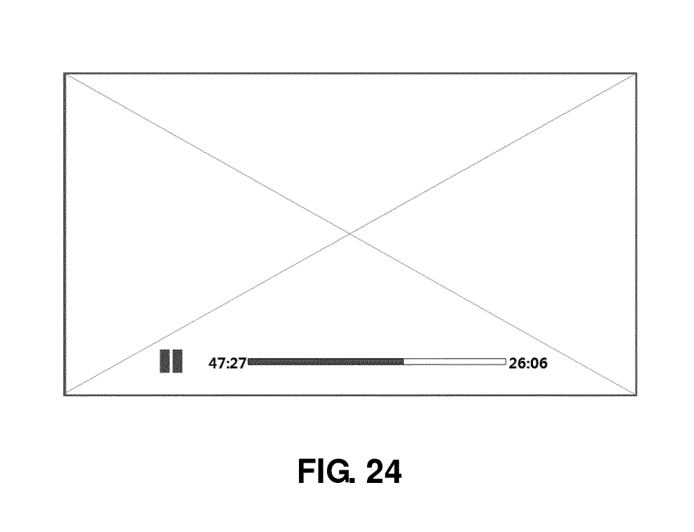

Referring again to FIG. 19, if there is Push action made by the user during the viewing of an on-demand program, the broadcast receiving device 102 may pause the playing of the on-demand program, as illustrated in FIG. 24.

Afterwards, if there is a Push action again, the playing of the on-demand program can be continued.

In an embodiment of the invention, a Shake action may be used for returning to the program currently being viewed (the A/V page 804).

For example, while a category list page, a program list page, etc., for program navigation is currently being outputted during the viewing of a particular program, if a Shake action by the user is detected, then the broadcast receiving device 102 may output the program that was previously being viewed as a full screen.

Also, while an option page is outputted for a program corresponding to each category according to a function call, if a Shake action by the user is detected, the broadcast receiving device 102 may output the program that was previously being viewed as a full screen.

If a Wheel action by the user is detected while a live program or an on-demand program is being outputted in FIG. 19, then the broadcast receiving device 102 may adjust the volume.

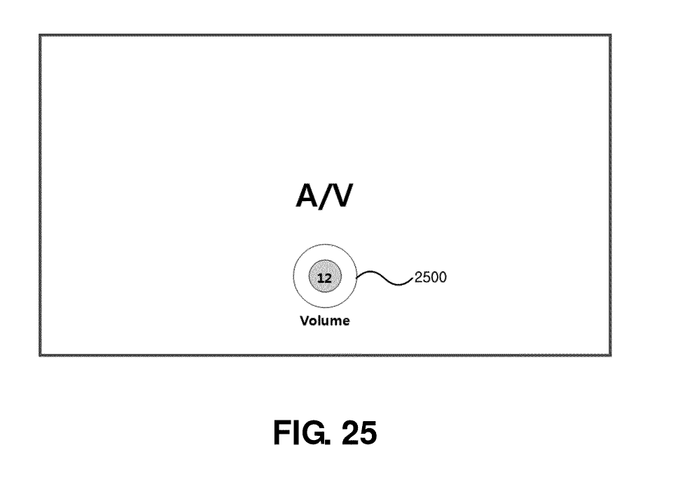

As illustrated in FIG. 25, if the user's Wheel action is detected, a volume icon 2500 may be outputted.

The broadcast receiving device 102 may, for example, increase the volume if the user's Wheel action is in a clockwise direction, and decrease the volume if it is in a counterclockwise direction.

Although it is not listed in Table 1, a broadcast receiving device 102 according to an embodiment of the invention can output a list of recently viewed programs upon detecting a Grip & Pull action.

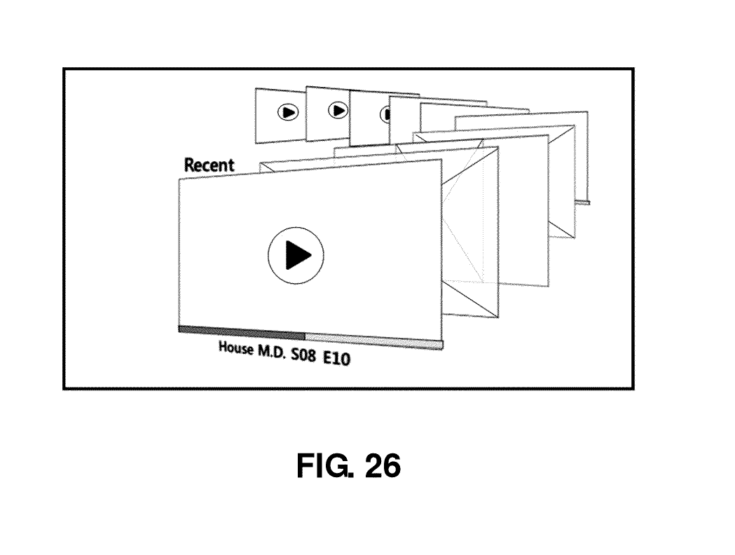

FIG. 26 illustrates a recently viewed program list according to the first example of an embodiment of the invention.

If a Grip & Pull action is detected while the viewer is viewing a live program or an on-demand program, the broadcast receiving device 102 may output a recently viewed program list (Recent) displayed in chronological order, as illustrated in FIG. 26.

For example, the recently viewed program list page can include information on the 10 most recently viewed programs.

In the recently viewed program list, the user can navigate programs by using the Grip & Drag action and select a program by using the Push or the Zoom In action.

Here, if a Shake action is detected, the broadcast receiving device 102 may output the program that was previously being viewed on the full screen.

According to an embodiment of the invention, a search service can be provided that is based on the user's hand motion and voice recognition.

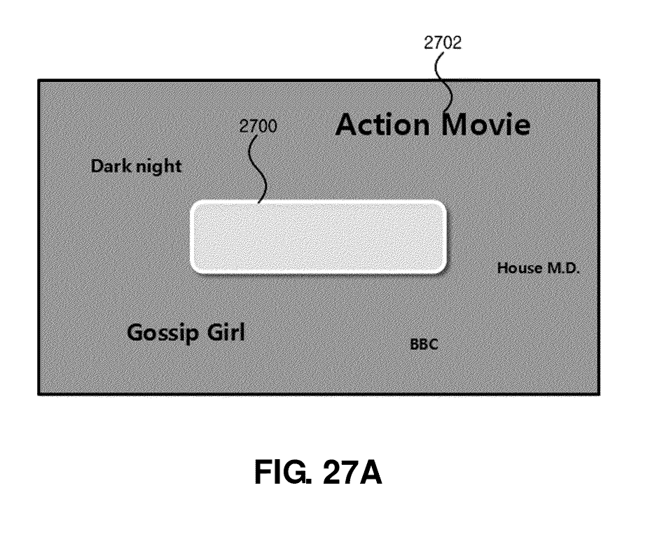

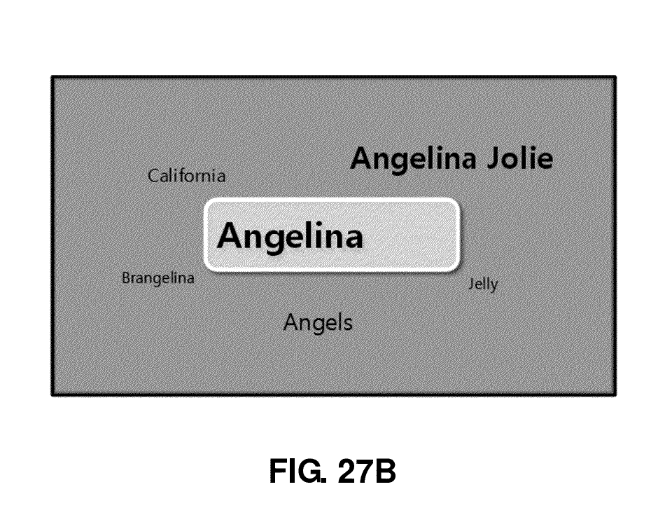

FIG. 27A and FIG. 27B illustrate a voice search page according to the first example of an embodiment of the invention.

If the user's voice is recognized while a program is being outputted as a full screen, then a voice search page can be outputted.

As illustrated in FIG. 27A and FIG. 27B, a voice search page according to an embodiment of the invention can include a search keyword activation area 2700.

Preferably, the search keyword activation area 2700 can be positioned at the center of the screen, which position may be defined as a focus area.

According to an embodiment of the invention, search keyword information 2702 pertaining to search keywords recently inputted by the user may be displayed around the search keyword activation area 2700.

In one example, the number of recent search keywords displayed on the screen can be five.

While the voice search page is outputted, if the user inputs his/her voice, the broadcast receiving device 102 may display a text corresponding to the recognized voice on the search keyword activation area 2700.

The user can select one of the recent search keywords and move it to the search keyword activation area 2700 by using a Grip & Drag action, and the broadcast receiving device 102 may output search results corresponding to the recent search keyword that was moved to the search keyword activation area 2700.

If a search keyword that is the same as or similar to the voice inputted by the user is positioned around the search keyword activation area 2700, the broadcast receiving device according to an embodiment of the invention can move the search keyword to the search keyword activation area 2700.

If a Push action by the user is detected while a search keyword is displayed in the search keyword activation area 2700, the broadcast receiving device 102 may output search results corresponding to the search keyword.

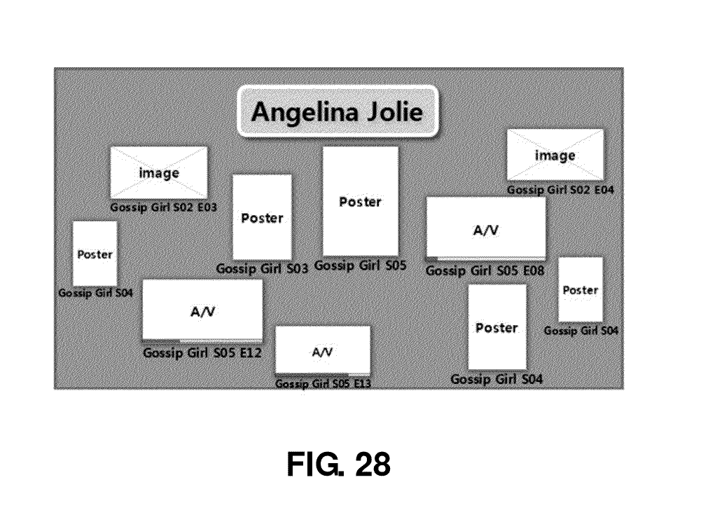

FIG. 28 illustrates a search result page according to the first example of an embodiment of the invention.

As illustrated in FIG. 28, a search result page according to an embodiment of the invention can include a search keyword display area 2800 and information on one or more programs corresponding to the search keyword.

If there are live, on-demand, and future programs included in the search results, the search result page may display live images for live programs and posters and representative images for on-demand and future programs.

The first example of an embodiment of the invention may thus provide pages having different depths, such as the category list page, program list page, A/V page and option pages and may output a page according to the user's hand motion, to enable the user to select a program from within the outputted page or select a particular function.

### (2) Second Example

A description is provided below of a second example of an embodiment of the invention for navigating programs through hand motion detection.

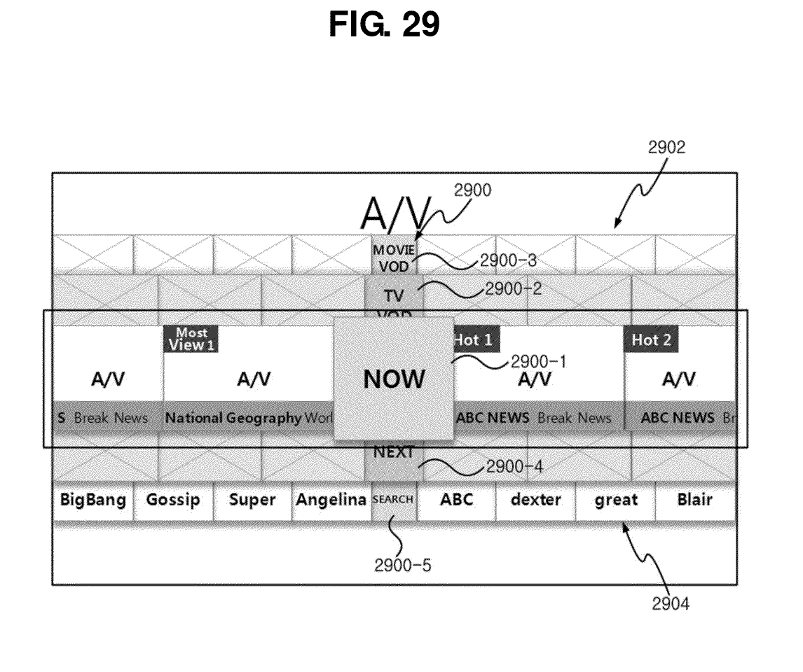

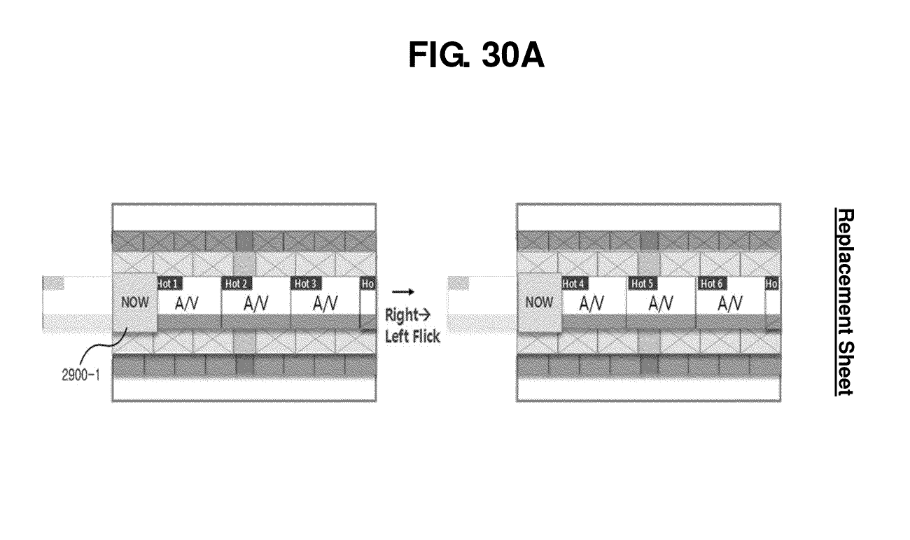

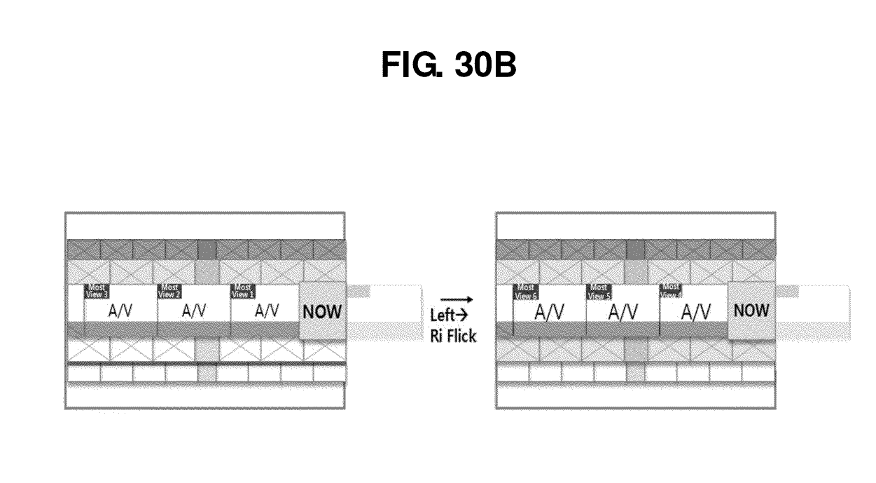

FIG. 29, FIG. 30A, and FIG. 30B illustrate a home menu page according to the second example of an embodiment of the invention.

The second example of an embodiment of the invention enables program navigation based on a home menu page such as that shown in FIG. 29, without requiring the category list page and program list page of the first example, and enables program navigation and selection focusing on the Flick and Push actions.

That is, according to the second example of an embodiment of the invention, the user is able to navigate and select programs even with a smaller number of hand motions.

Referring first to FIG. 29, a home menu page according to the second example of an embodiment of the invention can include category information 2900, program related information 2902, and search keyword information 2904.

The categories according to the second example of an embodiment of the invention can include live programs (NOW), on-demand programs (VOD), future programs (NEXT), and search. The on-demand programs can be divided into MOVIE VOD and TV VOD, which may be defined as serials.

When the home menu page is started according to the user's request, the broadcast receiving device 102 may output the category information 2900 with multiple categories aligned at certain positions of the screen.

Preferably, the broadcast receiving device 102 can output the category information 2900 with the categories aligned along the Y-axis direction of the center of the screen.

In addition, the broadcast receiving device 102 may align and output the program related information 2902 and search keyword information 2904 corresponding to each category along the left-right direction.

The broadcast receiving device 102 may, for the live program category, output a particular number of real-time images on the left and right of the live program category information 2900-1, and for the on-demand program category, may output a particular number of posters on the left and right of the on-demand program category information 2900-2/3.

The broadcast receiving device 102 may, for the future program category, output representative images for a particular number of future programs on the left and right of the future program category information 2900-4, and for the search category, may output a particular number of search keywords on the left and right of the search category information 2900-5.

Preferably, the program information arranged on the left and right of each category information 2900 can include information related to programs having the highest viewership ratings or popularity, and in the case of the search category, the search keywords arranged on the left and right can include recently searched keywords or popular keywords.

The center position 2910 of a home menu page according to an embodiment of the invention may be defined as a focus area, and if a Flick action by the user is detected, the broadcast receiving device 102 may perform a category movement and program navigation.

Here, the focus area can be defined along the X-axis direction at the center of the screen's Y-axis.

With the home menu page outputted as in FIG. 29, if a Flick action made by the user in the up-down direction is detected, the broadcast receiving device 102 may change the category displayed in the focus area as well as the program related information associated therewith.

For example, while the live program category information 2900-1 and its program related information are displayed in the focus area as in FIG. 29, if the user performs a Flick action from up to down, then the broadcast receiving device 102 may move one of the categories located above the live program category into the focus area.

If a Flick action in the left-right direction is detected, the broadcast receiving device 102 may perform navigation in the category positioned in the focus area.

FIG. 30A and FIG. 30B illustrate a program navigation procedure according to the second example of an embodiment of the invention.

FIG. 30A illustrates how the program related information 2902 displayed in the focus area may be moved when a Flick action from right to left is detected.

As illustrated in FIG. 30A, if the user's Flick action from right to left is detected, the broadcast receiving device 102 may move the category information 2900-1 to the left, and the program information for other programs may be outputted sequentially in descending order of viewership ratings.

FIG. 30B illustrates how the program related information 2902 displayed in the focus area may be changed when a Flick action from left to right is detected.

As illustrated in FIG. 30B, if the user's Flick action from right to left is detected, the broadcast receiving device 102 may move the category information 2900-1 to the right, and the program information for other programs may be outputted sequentially in ascending order of viewership ratings.

If a Push action by the user is detected for one of the program related information displayed in the focus area, the broadcast receiving device 102 may interpret this as a selection, to output the selected program as a full screen.

If the program selected by the user is an on-demand program that requires payment, the broadcast receiving device 102 can first output a page for purchasing, and then output the full screen (A/V page) when the purchase is completed.

Also, if the program selected by the user is a future program, the broadcast receiving device 102 may set a viewing reservation.

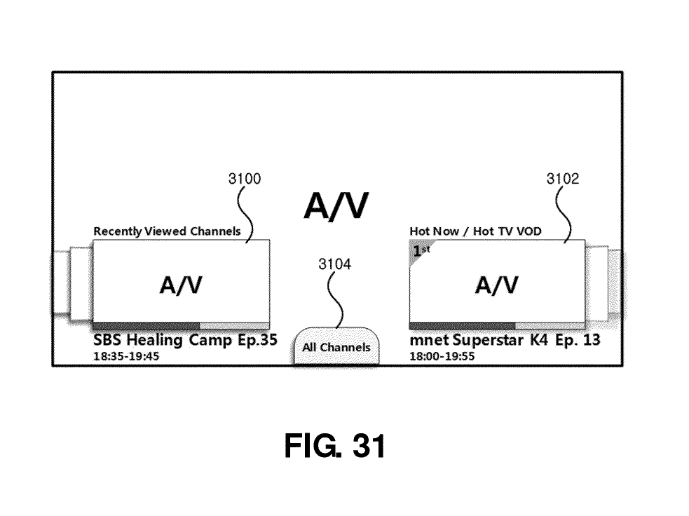

FIG. 31 illustrates a viewing option page according to the second example of an embodiment of the invention.

A viewing option page according to the second example of an embodiment of the invention can be outputted if a Flick action is detected while the user is viewing a program as a full screen.

Referring to FIG. 31, a viewing option page according to an embodiment of the invention can be displayed as an overlay while the A/V (preferably a live program) is being outputted in the background. The viewing option page can include recently viewed program information 3100, popular program information 3102, and all channel information 3104.

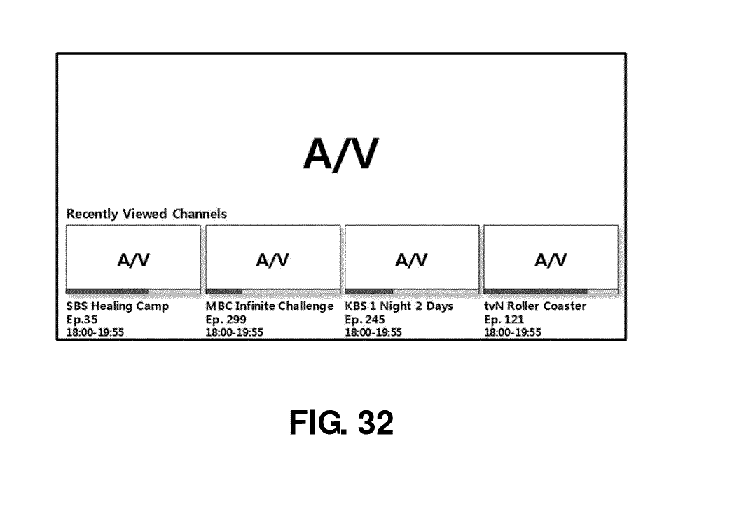

In cases where the recently viewed program information 3100 is arranged on the left of the screen as in FIG. 31, the broadcast receiving device 102 may output a recently viewed program list page, as in FIG. 32, if the user's Flick action from left to right is detected.

That is, the user's Flick action from left to right may be recognized as an action for expanding the information on the left of the screen.

As illustrated in FIG. 32, a recently viewed program list page can include live images, program names, and broadcast times of recently viewed programs.

By way of the left-right Flick action in the recently viewed program list page, a user can navigate through a multiple number of programs, and if a Push action is detected for one of the programs, the broadcast receiving device 102 may output the selected program as a full screen.

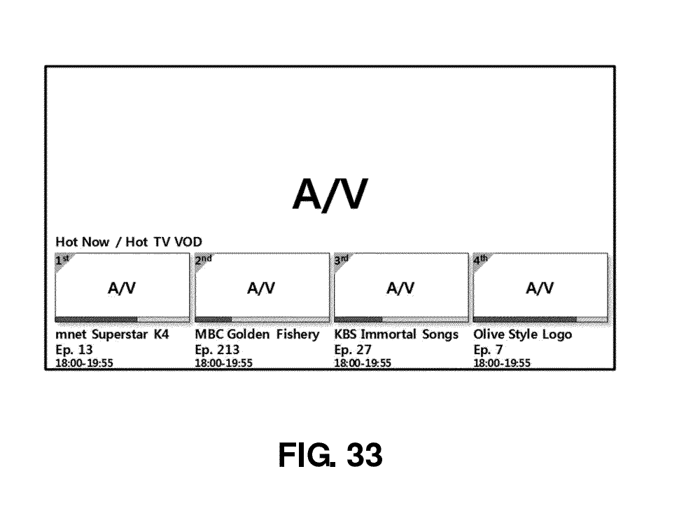

In cases where the popular program information 3102 is arranged on the right of the screen as in FIG. 31, the broadcast receiving device 102 may output a popular program list page, as in FIG. 33, if the user's Flick action from right to left is detected.

Similar to the recently viewed program list page, the user can utilize the left-right Flick and Push actions to navigate through and select programs having high popularity.

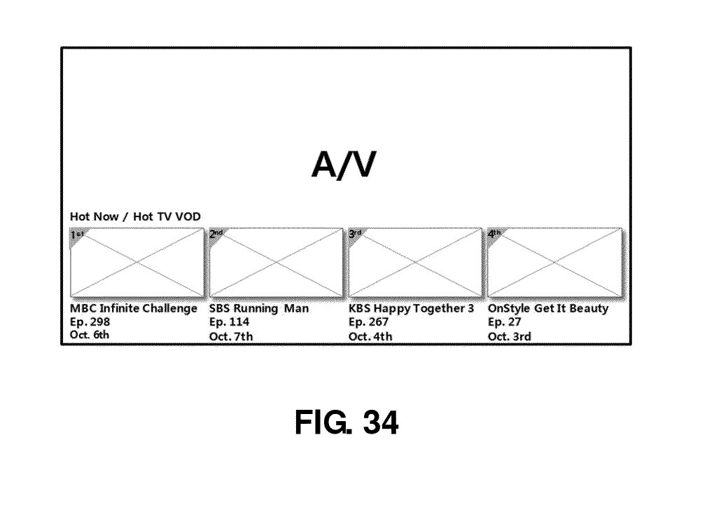

Here, the popular programs can be programs having high viewership ratings, and in the case of the viewed program being an on-demand program, the popular program list page, such as that illustrated in FIG. 34, can include programs that have been purchased frequently or have received favorable evaluations.

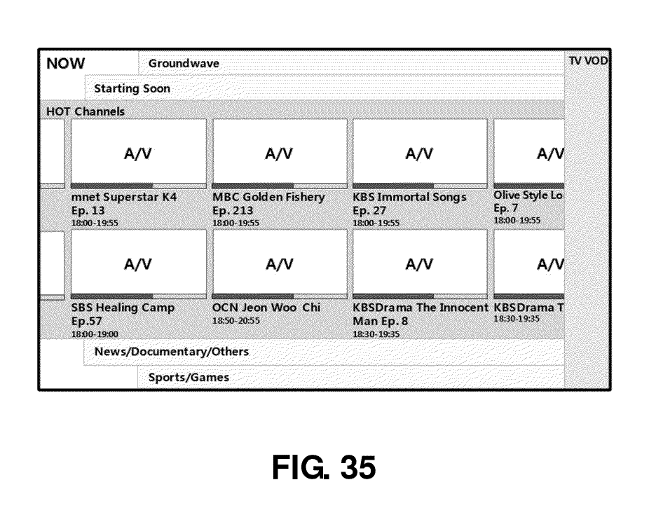

In FIG. 31, while the all channel information 3104 is arranged at the bottom of the screen, if the user's Flick action from down to up is detected, an all channel list page may be outputted such as that shown in FIG. 35.

As illustrated in FIG. 35, an all channel list page can include program information grouped according to ratings (popularity) and genre.

In the all channel list page, the user can navigate the desired programs through the left-right Flick or up-down Flick actions.

According to the second example of an embodiment of the invention, the Wheel action may be used for volume adjustment and for section navigation in an on-demand program.

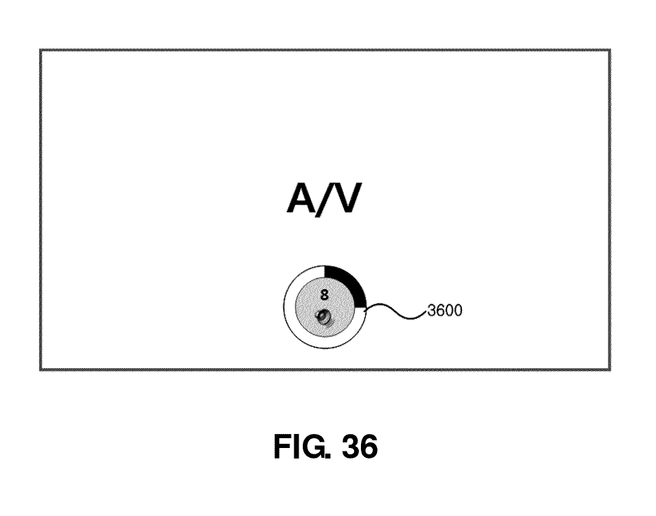

If the user's Wheel action is detected while a program is being outputted as a full screen, the broadcast receiving device 102 may output a volume icon 3600, such as that shown in FIG. 36, and may adjust the volume according to the direction of the user's Wheel action.

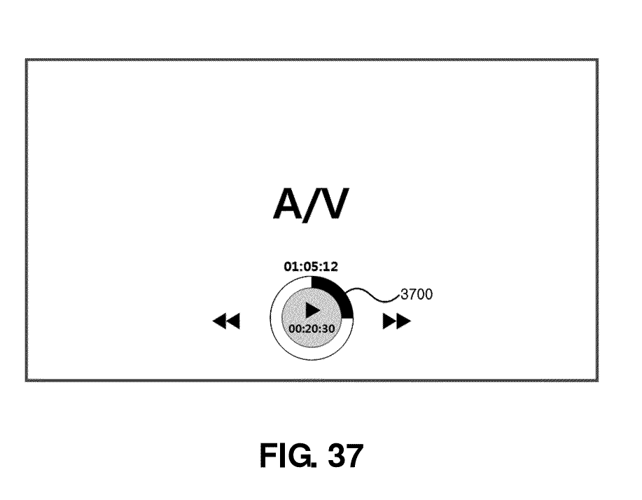

If the user's Push action is detected while an on-demand program is being outputted, the broadcast receiving device 102 may pause the on-demand program and output a section navigation icon 3700, such as that shown in FIG. 37.

If the user's Wheel action is detected while the section navigation icon 3700 is outputted, the broadcast receiving device 102 may perform section navigation according to the direction of the Wheel.

For example, if the Wheel is a clockwise rotation, then the images of sections following the currently played section may be outputted, and if the Wheel is a counterclockwise rotation, then the images of sections preceding the currently played section may be outputted

Here, the images outputted in accordance to a Wheel action can be still images.

Also, the section navigation can be determined according to the number of rotations of the Wheel. For example, the section navigation can be performed in one-minute increments per one rotation.

If the user's Flick action is detected while the section navigation icon 3700 is outputted, then a fast-forward or rewind operation can be performed.

For example, if a Flick from right to left is detected, a fast-forward operation may be performed, where the speed of the fast-forwarding can be increased according to the number of Flick actions.

Conversely, if a Flick from left to right is detected, a rewinding operation may be performed, where the speed of the rewinding can be increased according to the number of Flick actions.

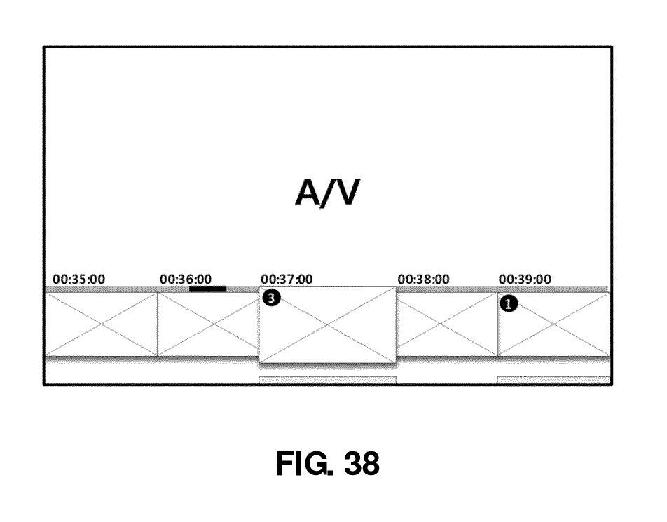

If a Flick action in the up-down direction is detected while an on-demand program is being played, the broadcast receiving device 102 may output multiple thumbnails with respect to the currently played section, as illustrated in FIG. 38.

The user can move the thumbnails with left-right Flick actions to navigate the desired section.

The thumbnail navigation, illustrated in FIG. 38, can be used for providing supplementary information related to the thumbnails.

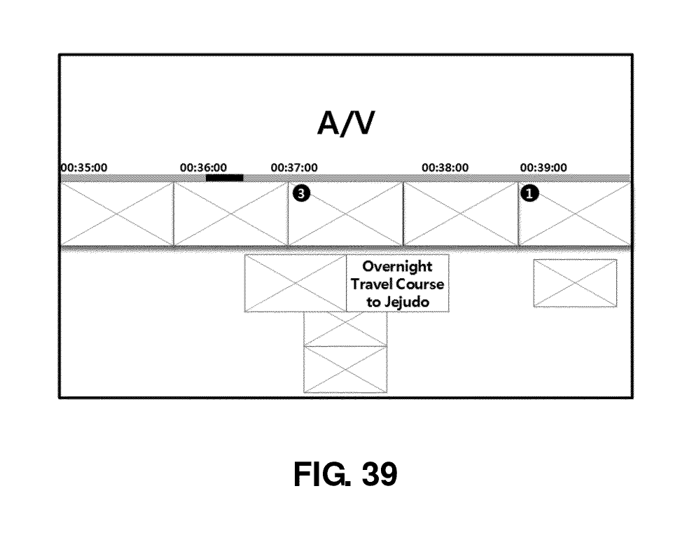

If the user's up-down Flick action is detected while a multiple number of thumbnails are outputted as in FIG. 38, the broadcast receiving device 102 may output supplementary information corresponding to each thumbnail, as illustrated in FIG. 39.

Here, the supplementary information can be displayed in the form of a thumbnail or text.

Preferably, in the thumbnail page such as that of FIG. 38, the broadcast receiving device 102 can selectively output supplementary information corresponding to only the thumbnail positioned at the center.

If the user makes a Push action for a particular set of supplementary information, the broadcast receiving device 102 may execute the selected supplementary information.

For example, if the supplementary information selected by the user is information relating to a travel location shown in the thumbnail, the broadcast receiving device 102 may send a request through a network to a server (not shown), requesting a page associated with the supplementary information, and may output it on the screen when it is received.

In an embodiment of the invention, the supplementary information can also be provided during the viewing of a live program.

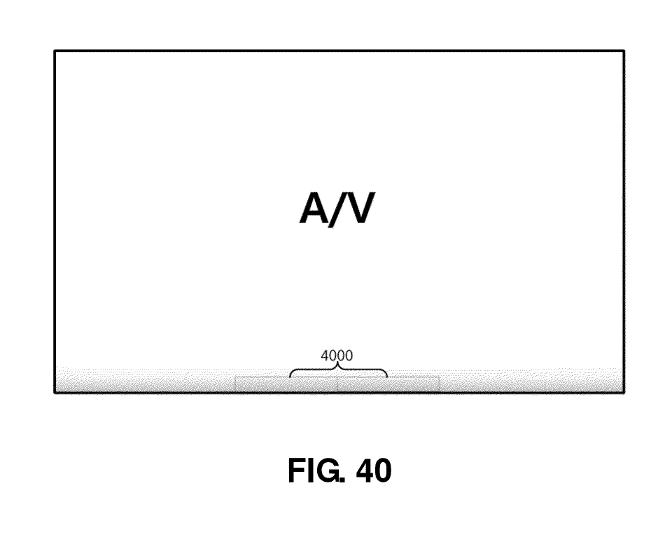

If there exists supplementary information related to the image displayed on the current screen while a live program is being outputted, the broadcast receiving device 102 can output a supplementary information indicator 4000 at a particular position of the screen as in FIG. 40.

If the user's Flick action from down to up is detected while a supplementary information indicator 4000 is shown at the bottom of the screen as in FIG. 40, then supplementary information may be displayed in the form of thumbnails, as in FIG. 39, and as the user inputs a Push action, the supplementary information may be displayed.

The second example of an embodiment of the invention described above provides the advantage of allowing the user to intuitively access a desired service by using a hand motion of moving left to right, right to left, down to up, or up to down for navigating a program or selecting a function.

Although the descriptions above are presented using the first example and the second example individually, it is obvious that the invention is not thus limited, and that the various hand motions and corresponding page changes described for the first example and the various hand motions and corresponding page changes described for the second example can be used in combination with one another.

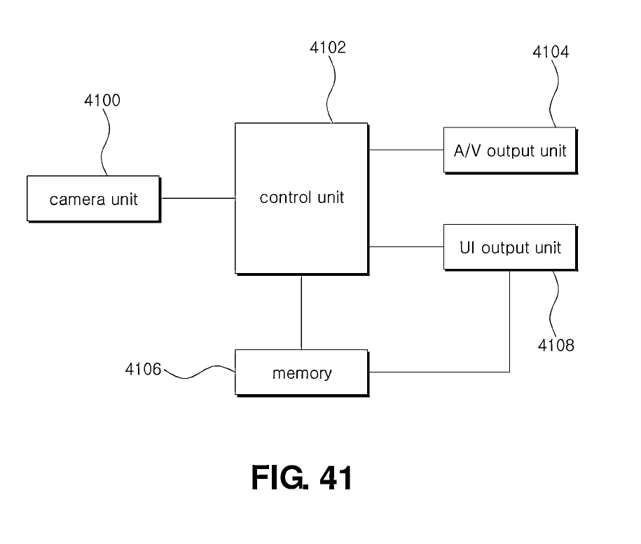

FIG. 41 illustrates the detailed composition of a broadcast receiving device according to an embodiment of the invention.

As illustrated in FIG. 41, a broadcast receiving device 102 according to an embodiment of the invention can include a camera unit 4100, a control unit 4102, an A/V output unit 4104, a memory 4106, and a UI output unit 4108.

The camera unit 4100 may capture the user's hand motions, and if it is determined that the user's hand motion captured by way of the camera unit 4100 is a pre-designated hand motion for program navigation, etc., the control unit 4102 may perform a corresponding control operation.

For example, if the user's hand motion is an action for selecting a program, the control unit 4102 may control the A/V output unit 4104 such that the program selected by the user is outputted on the screen.

Here, the A/V output unit 4104 may output the A/V as a full screen or, as described above, in a smaller size on any of the variety of list pages.

The memory 4106 may store the broadcast program schedule information received from the headend 100 and the program related information for the multiple number of broadcast programs.

If it is determined by the control unit 4102 that the user's hand motion is a request for a page for program navigation or selecting a function, the control unit 4102 may provide the control such that the UI output unit 4108 generates a page according to the user request.

Here, the UI output unit 4108 may use the information stored in the memory 4106 to generate a page for program navigation, etc., such as those illustrated in FIG. 9 through FIG. 40.

The embodiments of the present invention can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc. Examples of the program of instructions may include not only machine language codes produced by a compiler but also high-level language codes that can be executed by a computer through the use of an interpreter, etc. The hardware mentioned above can be made to operate as one or more software modules that perform the actions of the embodiments of the invention, and vice versa.

While the present invention has been described above using particular examples, including specific elements, by way of limited embodiments and drawings, it is to be appreciated that these are provided merely to aid the overall understanding of the present invention, the present invention is not to be limited to the embodiments above, and various modifications and alterations can be made from the disclosures above by a person having ordinary skill in the technical field to which the present invention pertains. Therefore, the spirit of the present invention must not be limited to the embodiments described herein, and the scope of the present invention must be regarded as encompassing not only the claims set forth below, but also their equivalents and variations.

What is claimed is:

1. A method for providing broadcast service at a broadcast receiving device through a detection of a user's hand motions, the method comprising:
(a) receiving schedule information for a plurality of broadcast programs from a headend;
(b) outputting a program selected by a user as a full screen; and
(c) outputting a program navigation page by using the schedule information of the plurality of broadcast programs if a pre-designated hand motion is detected, the program navigation page including one of a category list page and a program list page, the category list page containing a plurality of categories grouped according to use time, the program list page containing programs belonging to each category,
wherein a screen outputted in said step (c) is defined as an A/V page,
depths are assigned in an order of the category list page, the program list page, and the A/V page, from higher to lower depths, and a movement from a higher to a lower depth and a movement from a lower to a higher depth are performed via hand motions having different directionalities.

2. The method for providing broadcast service of claim 1, wherein said step (a) comprises further receiving information related to the plurality of broadcast programs from the headend, the related information comprising at least one of image information and program names,
and the program list page contains images and names of programs belonging to each category.

3. The method for providing broadcast service of claim 2, wherein the images of the programs within the program list page have different sizes according to viewership ratings or popularity of the programs.

4. The method for providing broadcast service of claim 1, wherein the hand motions having different directionalities comprise a zoom-in action of moving two hands closer together and a zoom-out action of moving two hands further apart.

5. The method for providing broadcast service of claim 1, wherein the categories are grouped into live programs, on-demand programs, and future programs.

6. The method for providing broadcast service of claim 1, wherein the category list page, the program list page, and the A/V page have a cyclical structure, and if a user's hand motion for moving from a higher depth to a lower depth is detected while the A/V page is outputted, then the category list page is outputted.

7. The method for providing broadcast service of claim 1, wherein the category list page and the program list page contain a focus area, and if a selection and a movement action through the user's hand motion is detected for one of the plurality of categories and the plurality of programs, a program list page corresponding to a selected category is outputted or a selected program is outputted as a full screen.

8. The method for providing broadcast service of claim 1, wherein, if the program list page is a page for on-demand programs, then a program option page for purchasing a selected program is outputted according to a pre-designated hand motion of the user,
and the program option page contains one of a poster display area, an episode icon, a detailed information icon, a popular program icon, and a related live program icon.

9. The method for providing broadcast service of claim 8, wherein the poster display area is defined as a focus area, and if there is a selection of one of the plurality of icons and a movement to the focus area resulting from the user's hand motion, then a page corresponding to the selected icon is outputted.

10. The method for providing broadcast service of claim 1, wherein, if the program list page is a page for future programs, then a program option page for a selected program is outputted according to a pre-designated hand motion of the user,
and the program option page contains at least one of an image display area, a detailed information icon, a popular program icon, and a viewing reservation program icon.

11. The method for providing broadcast service of claim 1, further comprising outputting a search page according to the user's request,
wherein the search page contains a search keyword activation area and search keyword information on a plurality of recently searched keywords, and if there is a selection of one of the plurality of search keywords and a movement to the search keyword activation area via the user's hand motion, then a search result corresponding to the selected search keyword is outputted.

12. A method for providing broadcast service at a headend through a detection of a user's hand motions, the method comprising:
(a) transmitting schedule information for a plurality of broadcast programs and page composition information for program navigation to a broadcast receiving device; and
(b) transmitting audio and video signals of a program selected by the user to the broadcast receiving device,
wherein the broadcast receiving device outputs a program navigation page by using the schedule information for the plurality of broadcast programs and the composition information if a pre-configured hand motion is detected while the selected program is outputted as a full screen,
the program navigation page including one of a category list page and a program list page, the category list page containing a plurality of categories grouped according to use time, the program list page containing programs belonging to each category,
the screen outputted as a full screen is defined as an A/V page, depths are assigned in an order of the category list page, the program list page, and the A/V page, from higher to lower depths, and a movement from a higher to a lower depth and a movement from a lower to a higher depth are performed via hand motions having different directionalities.

13. A method for providing broadcast service at a broadcast receiving device through a detection of a user's hand motions, the method comprising:
(a) receiving schedule information for a plurality of broadcast programs and related information from a headend, the related information for the broadcast programs comprising at least one of image information and program names;
(b) outputting a home menu page for navigating programs by using the schedule information for the plurality of broadcast programs, the home menu page containing a plurality of categories and related information for programs belonging to each category;
(c) selecting a category according to a pre-configured first hand motion of the user while the home menu page is outputted; and
(d) performing navigation for programs belonging to the selected category if a pre-configured second hand motion of the user is detected after the category is selected.

14. The method for providing broadcast service of claim 13, wherein the plurality of categories are aligned along a Y-axis direction and the related information for the plurality of programs belonging to each of the plurality of categories is aligned along an X-axis direction when displayed within the home menu page.

15. The method for providing broadcast service of claim 14, wherein a particular point along the Y-axis direction is defined as a focus area,
and wherein one of the plurality of categories is moved to the focus area according to the first hand motion, and the navigation is performed according to the second hand motion for programs belonging to the category positioned in the focus area.

16. The method for providing broadcast service of claim 15, wherein the first hand motion is a flick in an up-down direction and the second hand motion is a flick in a left-right direction.

17. The method for providing broadcast service of claim 15, wherein the home menu page further contains a search keyword area aligned along a Y-axis direction, and search keywords recently searched by the user or popular search keywords are aligned along an X-axis direction with respect to the search keyword area.

18. The method for providing broadcast service of claim 15, wherein said step (d) comprises:
sequentially outputting the plurality of programs belonging to the selected category in an order of viewership ratings or popularity, centering on the focus area.

19. The method for providing broadcast service of claim 15, wherein, if a push action of the user is detected in said step (d), then a program positioned in the focus area is outputted as a full screen.

20. The method for providing broadcast service of claim 19, further comprising:
performing a section navigation if a wheel action by the user is detected, if the program outputted as the full screen is an on-demand program.
